(19) United States
(12) Patent Application Publication
(10) Pub. No.: US 2025/0126293 A1
(43) Pub. Date: Apr. 17, 2025

(54) REFERENCE FRAMES FOR POINT CLOUD COMPRESSION

(71) Applicant: QUALCOMM Incorporated, San Diego, CA (US)

(72) Inventors: Adarsh Krishnan Ramasubramonian, Irvine, CA (US); Geert Van der Auwera, San Diego, CA (US); Marta Karczewicz, San Diego, CA (US)

(21) Appl. No.: 18/911,872

(22) Filed: Oct. 10, 2024

Related U.S. Application Data
(60) Provisional application No. 63/589,602, filed on Oct. 11, 2023.
(60) Provisional application No. 63/620,580, filed on Jan. 12, 2024.

(51) Int. Cl. H04N 19/597; H04N 19/159; H04N 19/172; H04N 19/423

(52) U.S. Cl. CPC H04N 19/597; H04N 19/159; H04N 19/172; H04N 19/423

(57) ABSTRACT

A device for decoding point cloud data includes: one or more memories configured to store the point cloud data; and processing circuitry coupled to the one or more memories, wherein the processing circuitry is configured to: apply a first process to a reference point cloud frame to generate a first level processed frame; apply a second process to the first level processed frame to generate a second level processed frame; inter-prediction decode geometry data of points of a current point cloud frame using the first level processed frame; and inter-prediction decode attribute data of points of the current point cloud frame using the second level processed frame.

This application claims the benefit of U.S. Provisional Application No. 63/589,602, filed Oct. 11, 2023, and U.S. Provisional Application No. 63/620,580, filed Jan. 12, 2024, the entire contents of each of which are incorporated herein by reference.

### TECHNICAL FIELD

This disclosure relates to point cloud encoding and decoding.

### BACKGROUND

A point cloud is a collection of points in a 3-dimensional space. The points may correspond to points on objects within the 3-dimensional space. Thus, a point cloud may be used to represent the physical content of the 3-dimensional space. Point clouds may have utility in a wide variety of situations. For example, point clouds may be used in the context of autonomous vehicles for representing the positions of objects on a roadway. In another example, point clouds may be used in the context of representing the physical content of an environment for purposes of positioning virtual objects in an augmented reality (AR) or mixed reality (MR) application. Point cloud compression is a process for encoding and decoding point clouds. Encoding point clouds may reduce the amount of data required for storage and transmission of point clouds.

### SUMMARY

In general, this disclosure describes techniques for generating prediction samples for coding (e.g., encoding or decoding) a current frame of point cloud data (e.g., improvements to inter-prediction for predictive geometry coding of point clouds). For instance, an encoder or decoder may perform one or more levels of processing on a reference frame of point cloud data, and code (e.g., encode or decode) a current frame of point cloud data based on the processed reference frame. With the example techniques described in the disclosure, there may be a reduction in an amount of information that is stored for performing coding, while minimizing loss in image quality. Accordingly, the example techniques may improve the buffer usage (e.g., reduce amount of information that needs to be stored) for the practical application of encoding or decoding point cloud data.

In one example, the disclosure describes a device for decoding point cloud data, the device comprising: one or more memories configured to store the point cloud data; and processing circuitry coupled to the one or more memories, wherein the processing circuitry is configured to: apply a first process to a reference point cloud frame to generate a first level processed frame; apply a second process to the first level processed frame to generate a second level processed frame; inter-prediction decode geometry data of points of a current point cloud frame using the first level processed frame; and inter-prediction decode attribute data of points of the current point cloud frame using the second level processed frame.

In one example, the disclosure describes a device for encoding point cloud data, the device comprising: one or more memories configured to store the point cloud data; and processing circuitry coupled to the one or more memories, wherein the processing circuitry is configured to: apply a first process to a reference point cloud frame to generate a first level processed frame; apply a second process to the first level processed frame to generate a second level processed frame; inter-prediction encode geometry data of points of a current point cloud frame using the first level processed frame; and inter-prediction encode attribute data of points of the current point cloud frame using the second level processed frame.

In one example, the disclosure describes a method of decoding point cloud data, the method comprising: applying a first process to a reference point cloud frame to generate a first level processed frame; applying a second process to the first level processed frame to generate a second level processed frame; inter-prediction decoding geometry data of points of a current point cloud frame using the first level processed frame; and inter-prediction decoding attribute data of points of the current point cloud frame using the second level processed frame.

In one example, the disclosure describes one or more computer-readable storage media storing instructions thereon that when executed cause one or more processors to: apply a first process to a reference point cloud frame to generate a first level processed frame; apply a second process to the first level processed frame to generate a second level processed frame; inter-prediction encode geometry data of points of a current point cloud frame using the first level processed frame; and inter-prediction encode attribute data of points of the current point cloud frame using the second level processed frame.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 is a block diagram illustrating an example Geometry Point Cloud Compression (G-PCC) encoder.

FIG. 3 is a block diagram illustrating an example G-PCC decoder.

FIG. 4 is a conceptual diagram illustrating an example of octree split for geometry coding.

FIG. 5 is a conceptual diagram illustrating an example of a prediction tree.

FIGS. 6A and 6B are conceptual diagrams illustrating an example of a spinning LIDAR acquisition model.

FIG. 7 is a conceptual diagram illustrating an example of inter-prediction of a current point (curPoint) from a point (interPredPt) in a reference frame.

FIG. 8 is a block diagram illustrating an example geometry encoding unit of FIG. 2 in more detail.

FIG. 9 is a block diagram illustrating an example attribute encoding unit of FIG. 2 in more detail.

FIG. 10 is a block diagram illustrating an example geometry decoding unit of FIG. 3 in more detail.

FIG. 11 is a block diagram illustrating an example attribute decoding unit of FIG. 3 in more detail.

FIG. 12 is a flow diagram illustrating an example of decoding point cloud data.

FIG. 13 is a conceptual diagram illustrating an example of identifying an additional inter predictor point obtained from a first point that has azimuth greater than the inter prediction point.

FIG. 14 is a flow diagram illustrating an example of generating a compensated reference frame from a reference frame.

FIG. 15 is a conceptual diagram illustrating an example of azimuth resampling of motion compensated reference.

FIG. 16 is a flow diagram illustrating an example of spherical coordinate conversion.

FIG. 17 is a flow diagram illustrating example of values for geometry and attribute prediction.

FIG. 18 is a flow diagram illustrating an example of generating a spherical table for inter-prediction.

FIG. 19 is a flow diagram illustrating an example of applying a first process on a reference frame.

FIG. 20 is a flow diagram illustrating another example of applying a first process on a reference frame.

FIG. 21 is a flow diagram illustrating another example of generating a spherical table for inter-prediction.

FIG. 22 is a flow diagram illustrating an example of applying scale and offset.

FIG. 23 is a flow diagram illustrating an example of generating a processed frame based on a spherical table.

FIG. 24 is a flow diagram illustrating another example of values for geometry and attribute prediction.

FIG. 25 is a flow diagram illustrating an example in which points are dropped.

FIG. 26 is a flow diagram illustrating an example in which dropped points are appended back.

FIG. 27 is a flow diagram illustrating an example of outputting a list of dropped points.

FIG. 28 is a conceptual diagram illustrating an example range-finding system that may be used with one or more techniques of this disclosure.

FIG. 29 is a conceptual diagram illustrating an example vehicle-based scenario in which one or more techniques of this disclosure may be used.

FIG. 30 is a conceptual diagram illustrating an example extended reality system in which one or more techniques of this disclosure may be used.

FIG. 31 is a conceptual diagram illustrating an example mobile device system in which one or more techniques of this disclosure may be used.

FIG. 32 is a flowchart illustrating example techniques of encoding point cloud data.

FIG. 33 is a flowchart illustrating example techniques of decoding point cloud data.

### DETAILED DESCRIPTION

A point cloud contains a set of points in a 3D space and may have attributes associated with the points. The attribute may be color information such as R, G, B or Y, Cb, Cr, or reflectance information, or other attributes. Point clouds may be captured by a variety of cameras or sensors such as LIDARs, 3D scanners and may also be computer-generated. Point cloud data refers to the attribute data (e.g., color, reflectance, etc.) and/or geometry data (e.g., coordinates). Point cloud data are used in a variety of applications including, but not limited to, construction (e.g., modeling), graphics (e.g., 3D models for visualizing and animation), and automotive industry (e.g., LIDAR sensors used to help in navigation).

The point cloud data may be represented as frames, where a frame includes point cloud data captured over time (e.g., one frame includes point data of points captured over one rotation of a LIDAR sensor). A point cloud encoder may be configured to encode the point cloud data to compress the amount of information that is signaled for a frame, and a point cloud decoder may be configured to decode the point cloud data to reconstruct the frame.

Examples of the encoding and decoding techniques include inter-prediction encoding or decoding and intra-prediction encoding or decoding. In inter-prediction encoding or decoding, the point cloud encoder or point cloud decoder determine geometry data and attribute data of one point in a current frame based on geometry data and attribute data of a point in a reference frame. The point that forms as a reference in the reference frame for geometry data and attribute data may be the same point or may be different points (e.g., one point as reference for geometry data and another point as reference for attribute data). In intra-prediction encoding or decoding, the point cloud encoder or point cloud decoder determine geometry data and attribute data of one point in a frame based on geometry data and attribute data of a point or points in the same frame.

In one or more examples, the point cloud encoder and the point cloud decoder may apply a first process to a reference point cloud frame to generate a first level processed frame. The point cloud encoder may perform inter-prediction encoding of geometry data, and the point cloud decoder may perform inter-prediction decoding of geometry data of points in a current point cloud frame using the first level processed frame.

In accordance with one or more examples described in this disclosure, rather than going back to the reference point cloud frame to generate information used for attribute data encoding or decoding, the point cloud encoder and the point cloud decoder may apply a second process to the first level processed frame to generate a second level processed frame. The point cloud encoder may perform inter-prediction encoding of attribute data, and the point cloud decoder may perform inter-prediction decoding of attribute data of points in the current point cloud frame using the second level processed frame.

In one or more examples, the second level processed frame may also include coordinate information. It is this coordinate information that is used for encoding or decoding attribute data. For instance, the actual attribute data (e.g., color, reflectance, etc.) may be associated with the coordinate information of points in the second level processed frame. Accordingly, both the first level processed frame and the second level processed frame may include coordinate information, but the coordinate information in the first level processed frame may be used for inter-prediction encoding or decoding geometry data, and the coordinate information in the second level processed frame may be used for inter-prediction encoding or decoding attribute data.

In this manner, rather than using two different buffers: one for inter-predicting geometry data and another for inter-predicting attribute data, the point cloud encoder and the point cloud decoder may maintain one buffer that stores the first level processed frame for inter-predicting geometry data. For inter-predicting attribute data, the point cloud encoder and the point cloud decoder may generate the second level processed frame from the first level processed frame.

Stated another way, because the point cloud encoder and the point cloud decoder generate the second level processed frame from the first level processed frame, the amount of data that is maintained from completion of encoding or decoding the reference point cloud frame to the start of encoding or decoding the current point cloud frame is reduced. For instance, both the first level processed frame and the second level processed frame may not need to be stored from completion of encoding or decoding the reference point cloud frame to the start of encoding or decoding the current point cloud frame. In this manner, the example techniques may reduce the amount of data that is maintained from frame-to-frame, thereby reducing memory storage requirements.

As described above, the point cloud encoder and the point cloud decoder may apply the first process to the reference point cloud frame to generate the first level processed frame. Also, the point cloud encoder and the point cloud decoder may apply the second process to the first level processed frame to generate the second level processed frame. In one or more examples, the points in the current frame and the reference frame may be represented by spherical coordinates including one or more of a radius component, an azimuth component (sometimes referred to as phi), and a laser identification component, which may be useful because each laser (e.g., in a LIDAR system) used for capturing the points may be at a different elevation or height. The point cloud encoder and the point cloud decoder may apply the first process and the second process using the spherical coordinates.

As one example, to the apply the first process, the point cloud encoder and the point cloud decoder may for each of a plurality of quantized azimuth components and for a laser identification component, store, in a table, a radius component and an azimuth component for k number of points (e.g., greater than or equal to 1) of the reference point cloud frame associated with the laser identification component. In this example, each of the plurality of quantized azimuth components is an index to the table, and the table is at least a portion of the first level processed frame. The value of k may be signaled or received in some examples, but may be preset in some examples.

As one example, to apply the second process, the point cloud encoder and the point cloud decoder may for each point in the first level processed frame, apply an offset and a scale to one or more of a radius component, an azimuth component, and a laser identification component to generate the second level processed frame. The value of the offset and scale may be signaled or received in some examples, but may be preset in some examples.

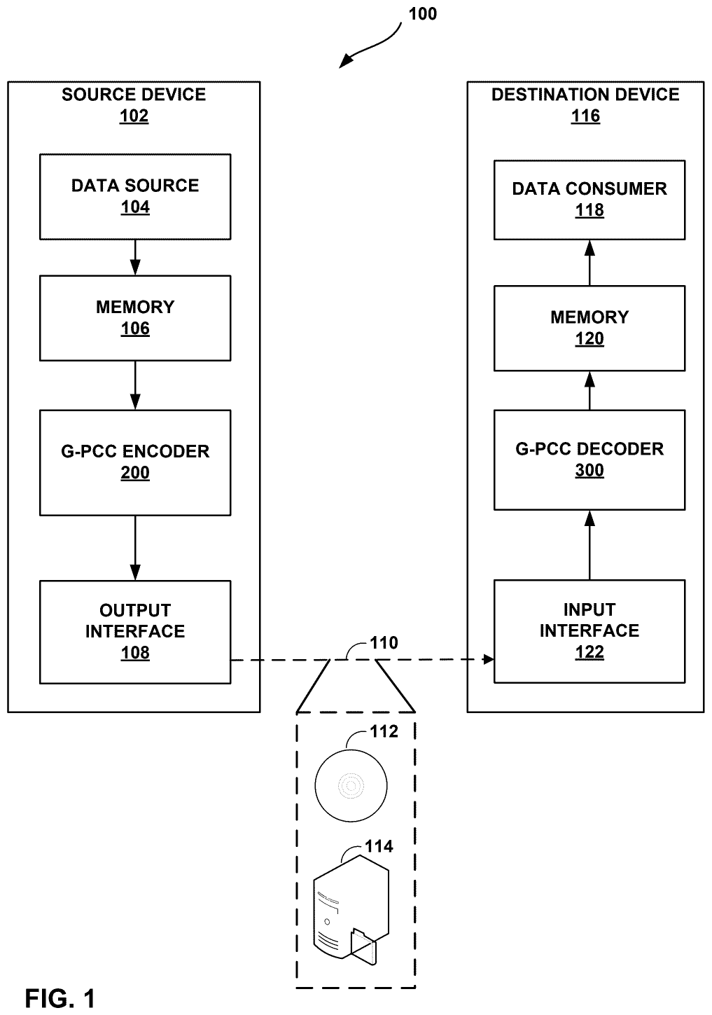

FIG. 1 is a block diagram illustrating an example encoding and decoding system 100 that may perform the techniques of this disclosure. The techniques of this disclosure are generally directed to coding (encoding and/or decoding) point cloud data, i.e., to support point cloud compression. In general, point cloud data includes any data for processing a point cloud. The coding may be effective in compressing and/or decompressing point cloud data.

As shown in FIG. 1, system 100 includes a source device 102 and a destination device 116. Source device 102 provides encoded point cloud data to be decoded by a destination device 116. Particularly, in the example of FIG. 1, source device 102 provides the point cloud data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a Geometry Point Cloud Compression (G-PCC) encoder 200, and an output interface 108. Destination device 116 includes an input interface 122, a G-PCC decoder 300, a memory 120, and a data consumer 118. In accordance with this disclosure, G-PCC encoder 200 of source device 102 and G-PCC decoder 300 of destination device 116 may be configured to apply the techniques of this disclosure related to coding of point cloud data. Thus, source device 102 represents an example of an encoding device, while destination device 116 represents an example of a decoding device. In other examples, source device 102 and destination device 116 may include other components or arrangements. For example, source device 102 may receive data (e.g., point cloud data) from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to coding of point cloud data. Source device 102 and destination device 116 are merely examples of such devices in which source device 102 generates coded data for transmission to destination device 116. This disclosure refers to a “coding” device as a device that performs coding (encoding and/or decoding) of data. Thus, G-PCC encoder 200 and G-PCC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded point cloud data) and may provide a sequential series of “frames”) of the data to G-PCC encoder 200, which encodes data for the frames. Data source 104 of source device 102 may include a point cloud capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, point cloud data may be computer-generated from scanner, camera, sensor or other data. For example, data source 104 may generate computer graphics-based data as the source data, or produce a combination of live data, archived data, and computer-generated data. In each case, G-PCC encoder 200 encodes the captured, pre-captured, or computer-generated data. G-PCC encoder 200 may rearrange the frames from the received order (sometimes referred to as “display order”) into a coding order for coding. G-PCC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from G-PCC decoder 300. Additionally or alternatively, memory 106 and memory 120 may store software instructions executable by, e.g., G-PCC encoder 200 and G-PCC decoder 300, respectively. Although memory 106 and memory 120 are shown separately from G-PCC encoder 200 and G-PCC decoder 300 in this example, it should be understood that G-PCC encoder 200 and G-PCC decoder 300 may also include internal memories for functionally similar or equivalent purposes. Furthermore, memory 106 and memory 120 may store encoded data, e.g., output from G-PCC encoder 200 and input to G-PCC decoder 300. In some examples, portions of memory 106 and memory 120 may be allocated as one or more buffers, e.g., to store raw, decoded, and/or encoded data. For instance, memory 106 and memory 120 may store data representing a point cloud.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both, that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to G-PCC encoder 200 and/or output interface 108, and destination device 116 may include an SoC device to perform the functionality attributed to G-PCC decoder 300 and/or input interface 122.

The techniques of this disclosure may be applied to encoding and decoding point cloud data in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by G-PCC encoder 200, which is also used by G-PCC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on a point cloud.

G-PCC encoder 200 and G-PCC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of G-PCC encoder 200 and G-PCC decoder 300 may be included in one or more encoders or decoders, either of which may be integrated as part of a combined encoder/decoder (CODEC) in a respective device. A device including G-PCC encoder 200 and/or G-PCC decoder 300 may comprise one or more integrated circuits, microprocessors, and/or other types of devices.

G-PCC encoder 200 and G-PCC decoder 300 may operate according to a coding standard, such as video point cloud compression (V-PCC) standard or a geometry point cloud compression (G-PCC) standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, G-PCC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

ISO/IEC MPEG (JTC 1/SC 29/WG 11) and more recently ISO/IEC MPEG 3DG (JTC 1/SC29/WG 7), is studying the potential need for standardization of point cloud coding technology with a compression capability that significantly exceeds that of the current approaches and will target to create the standard. The group is working together on this exploration activity in a collaborative effort known as the 3-Dimensional Graphics Team (3DG) to evaluate compression technology designs proposed by their experts in this area.

Point cloud compression activities are categorized in two different approaches. The first approach is “Video point cloud compression” (V-PCC), which segments the 3D object, and project the segments in multiple 2D planes (which are represented as “patches” in the 2D frame), which are further coded by a legacy 2D video codec such as a High Efficiency Video Coding (HEVC) (ITU-T H.265) codec. The second approach is “Geometry-based point cloud compression” (G-PCC), which directly compresses 3D geometry i.e., position of a set of points in 3D space, and associated attribute values (for each point associated with the 3D geometry). G-PCC addresses the compression of point clouds in both Category 1 (static point clouds) and Category 3 (dynamically acquired point clouds). A recent draft of the G-PCC standard is available in G-PCC DIS, ISO/IEC JTC1/SC29/WG11 w19088, Brussels, Belgium, January 2020, and a description of the codec is available in G-PCC Codec Description v6, ISO/IEC JTC1/SC29/WG11 w19091, Brussels, Belgium, January 2020.

A point cloud contains a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

The 3D space occupied by a point cloud data may be enclosed by a virtual bounding box. The position of the points in the bounding box may be represented by a certain precision; therefore, the positions of one or more points may be quantized based on the precision. At the smallest level, the bounding box is split into voxels which are the smallest unit of space represented by a unit cube. A voxel in the bounding box may be associated with zero, one, or more than one point. The bounding box may be split into multiple cube/cuboid regions, which may be called tiles. Each tile may be coded into one or more slices. The partitioning of the bounding box into slices and tiles may be based on number of points in each partition, or based on other considerations (e.g., a particular region may be coded as tiles). The slice regions may be further partitioned using splitting decisions similar to those in video codecs.

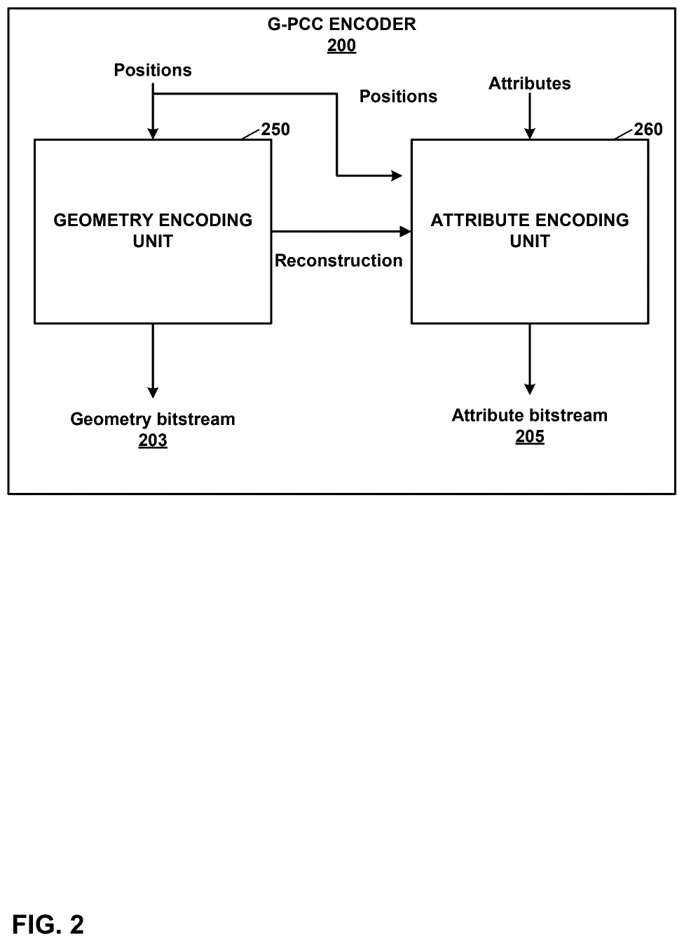

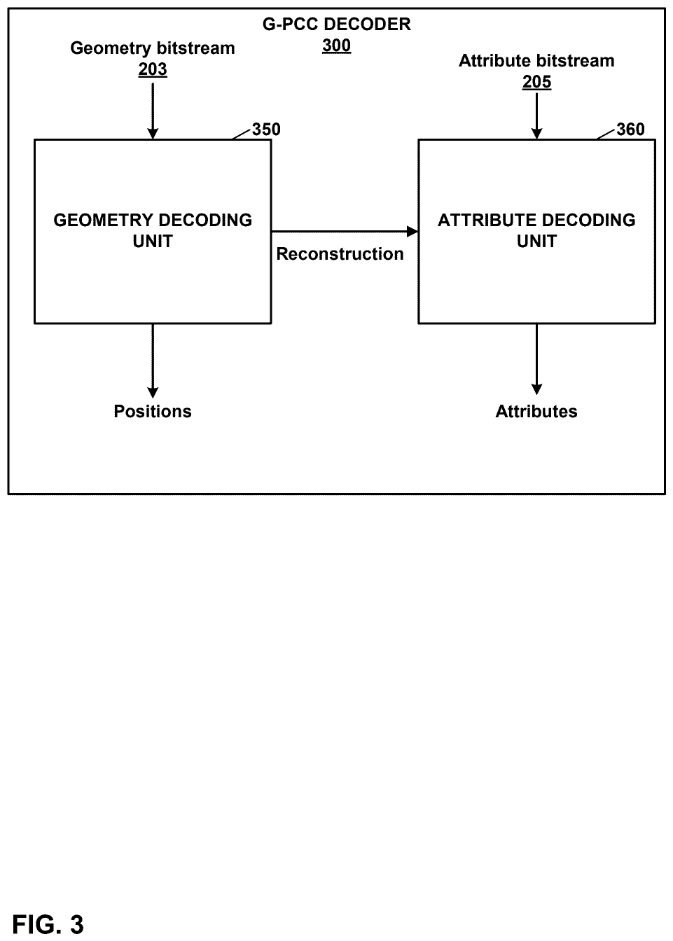

FIG. 2 provides an overview of G-PCC encoder 200. FIG. 3 provides an overview of G-PCC decoder 300. The modules shown are logical, and do not necessarily correspond one-to-one to implemented code. In the example of FIG. 2, G-PCC encoder 200 may include a geometry encoding unit 250 and an attribute encoding unit 260. In general, geometry encoding unit 250 is configured to encode the positions of points in the point cloud frame to produce geometry bitstream 203. Attribute encoding unit 260 is configured to encode the attributes of the points of the point cloud frame to produce attribute bitstream 205. As will be explained below, attribute encoding unit 260 may also use the positions, as well as the encoded geometry (e.g., the reconstruction) from geometry encoding unit 250 to encode the attributes.

In the example of FIG. 3, G-PCC decoder 300 may include a geometry decoding unit 350 and an attribute decoding unit 360. In general, geometry encoding unit 350 is configured to decode the geometry bitstream 203 to recover the positions of points in the point cloud frame. Attribute decoding unit 360 is configured to decode the attribute bitstream 205 to recover the attributes of the points of the point cloud frame. As will be explained below, attribute decoding unit 360 may also use the positions from the decoded geometry (e.g., the reconstruction) from geometry decoding unit 350 to encode the attributes.

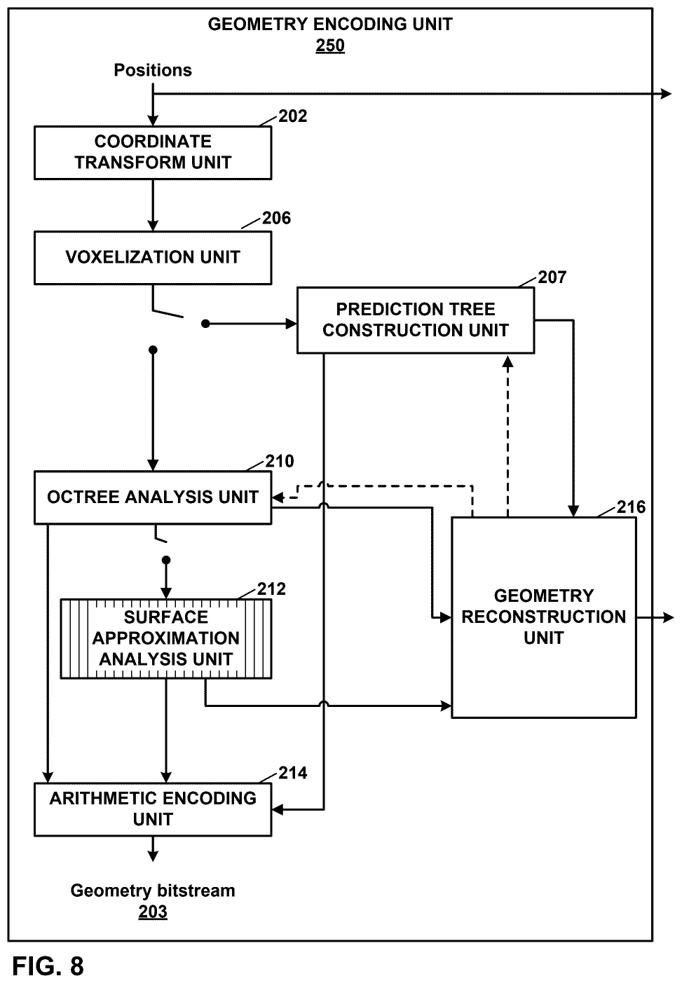

In both G-PCC encoder 200 and G-PCC decoder 300, point cloud positions are coded first. Attribute coding depends on the decoded geometry. In FIGS. 8-11 of this disclosure, the coding units with vertical hashing are options typically used for Category 1 data. Diagonal-crosshatched coding units are options typically used for Category 3 data. All the other modules are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

At each node of an octree, an occupancy is signaled (when not inferred) for one or more of its child nodes (up to eight nodes). Multiple neighborhoods are specified including (a) nodes that share a face with a current octree node, (b) nodes that share a face, edge or a vertex with the current octree node, etc. Within each neighborhood, the occupancy of a node and/or its children may be used to predict the occupancy of the current node or its children. For points that are sparsely populated in certain nodes of the octree, the codec also supports a direct coding mode where the 3D position of the point is encoded directly. A flag may be signaled to indicate that a direct mode is signaled. At the lowest level, the number of points associated with the octree node/leaf node may also be coded.

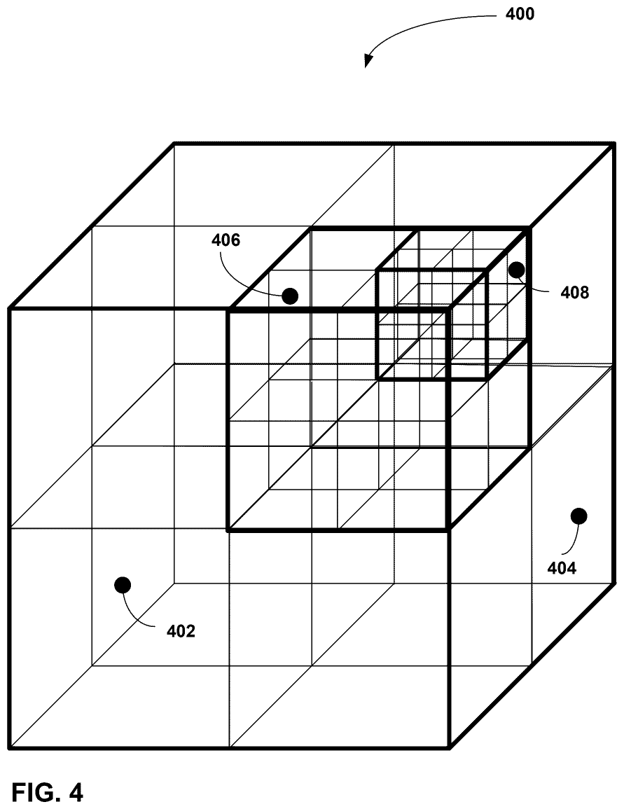

Once the geometry is coded, the attributes corresponding to the geometry points are coded. When there are multiple attribute points corresponding to one reconstructed/decoded geometry point, an attribute value may be derived that is representative of the reconstructed point. For instance, FIG. 4 illustrates octree split 400 for geometry coding, with points 402-408 each illustrating points at different levels of the octree split.

There are three attribute coding methods in G-PCC: Region Adaptive Hierarchical Transform (RAHT) coding, interpolation-based hierarchical nearest-neighbour prediction (Predicting Transform), and interpolation-based hierarchical nearest-neighbour prediction with an update/lifting step (Lifting Transform). RAHT and Lifting are typically used for Category 1 data, while Predicting is typically used for Category 3 data. However, either method may be used for any data, and, just like with the geometry codecs in G-PCC, the attribute coding method used to code the point cloud is specified in the bitstream.

The coding of the attributes may be conducted in a level-of-detail (LoD), where with each level of detail a finer representation of the point cloud attribute may be obtained. Each level of detail may be specified based on distance metric from the neighboring nodes or based on a sampling distance.

At G-PCC encoder 200, the residuals obtained as the output of the coding methods for the attributes are quantized. The residuals may be obtained by subtracting the attribute value from a prediction that is derived based on the points in the neighborhood of the current point and based on the attribute values of points encoded previously. The quantized residuals may be coded using context adaptive arithmetic coding.

G-PCC encoder 200 and G-PCC decoder 300 may be configured to code point cloud data using predictive geometry coding as an alternative to the octree geometry coding. In prediction tree coding, the nodes of the point cloud are arranged in a tree structure (which defines the prediction structure), and various prediction strategies are used to predict the coordinates of each node in the tree with respect to its predictors.

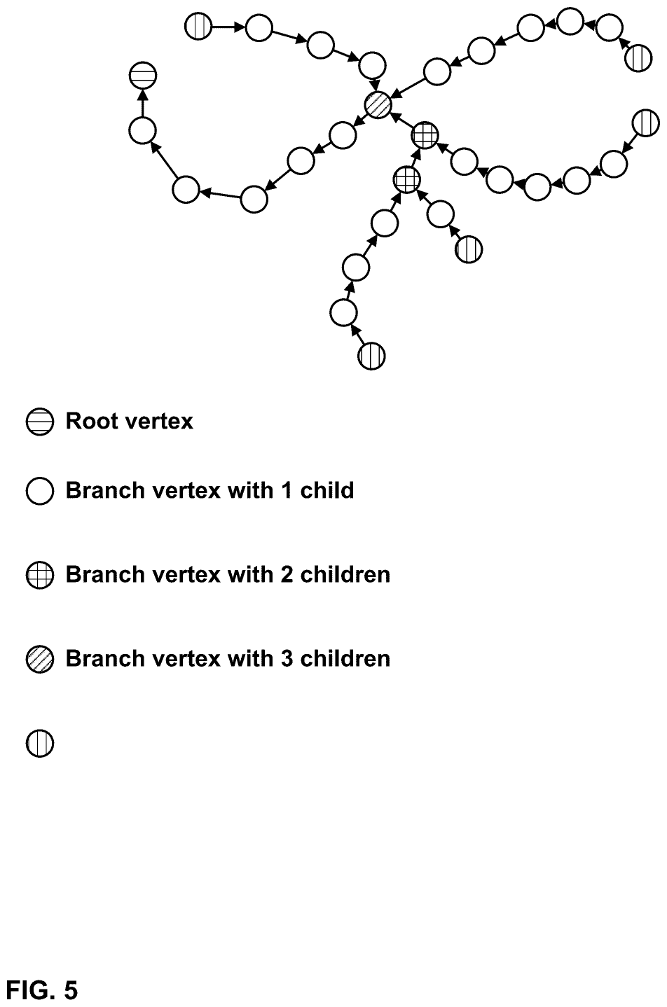

FIG. 5 is a conceptual diagram illustrating an example of a prediction tree. For instance, in FIG. 5 a directed graph where the arrow point to the prediction direction. An example node is the root vertex and has no predictors, another example of nodes have two children, another example of nodes has 3 children, another example of blue nodes have one child, and another example of nodes are leaf nodes and these have no children. Every node has only one parent node. In other words, a node that is the root vertex and has no predictors. Other nodes may have 1, 2, 3 or more children. Other nodes may be leaf nodes that have no children. In one example, every node of the predictive has only one parent node.

In one example, four prediction strategies are specified for each node based on its parent (p0), grand-parent (p1) and great-grand-parent (p2):
No prediction/zero prediction (0)
Delta prediction (p0)
Linear prediction (2*p0−p1)
Parallelogram prediction (2*p0+p1−p2)

G-PCC encoder 200 may employ any algorithm to generate the prediction tree; the algorithm used may be determined based on the application/use case and several strategies may be used. For each node, the residual coordinate values are coded in the bitstream starting from the root node in a depth-first manner. Predictive geometry coding may be particularly useful for Category 3 (LIDAR-acquired) point cloud data, e.g., for low-latency applications.

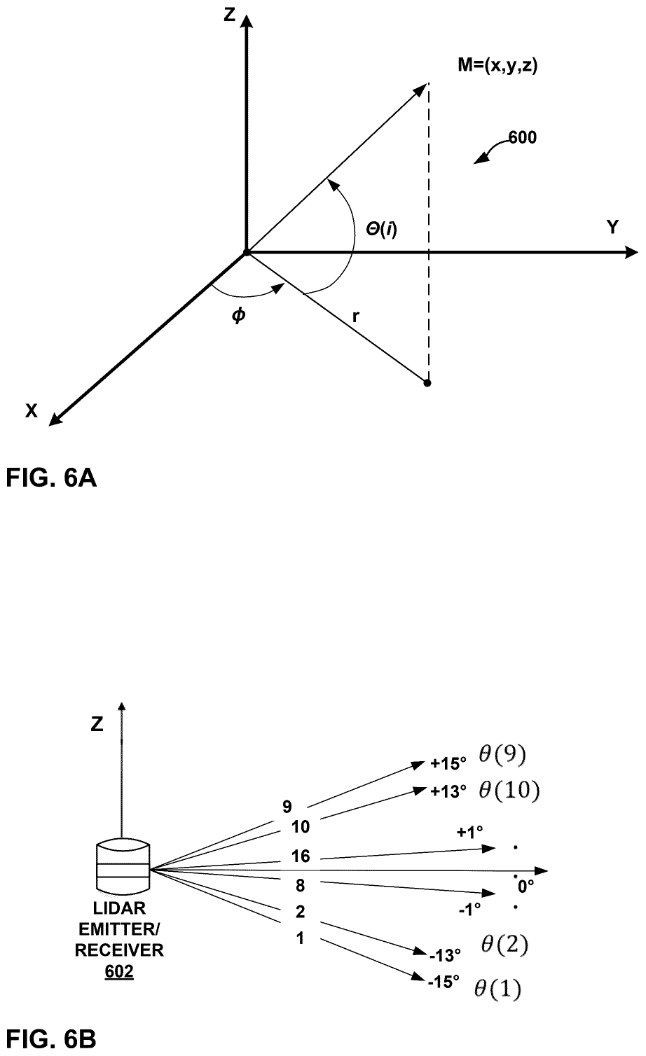

FIGS. 6A and 6B are conceptual diagrams illustrating an example of a spinning LIDAR acquisition model. LIDAR 602 may be used in automotive, mobile computing, aviation, and other scenarios. In some examples, angular mode may be used in predictive geometry coding, where the characteristics of LIDAR sensors may be utilized in coding the prediction tree more efficiently. The coordinates of the positions are converted to the (r, ϕ, i) (radius, azimuth and laser index) domain 600 and a prediction is performed in this domain 600 (the residuals are coded in r, ϕ, i domain). The laser index is also referred to as the laser identification component. Accordingly, the coordinates of the positions include one or more of a radius component (also called rad), an azimuth component (also called phi), and a laser identification component (also called laserID or laser index). Due to the errors in rounding, coding in r, ϕ, i is not lossless and hence a second set of residuals are coded which correspond to the Cartesian coordinates. A description of the encoding and decoding strategies used for angular mode for predictive geometry coding is provided below.

Angular mode for predictive geometry coding may be used with point clouds acquired using a spinning LIDAR model. Here, the LIDAR 602 has N lasers (e.g., N=16, 32, 64) spinning around the Z axis according to an azimuth angle ϕ. Each laser may have different elevation θ(i)_{i=1 . . . N} and height ç(i)_{i=1 . . . N}. In one example, laser i hits a point M, with cartesian integer coordinates (x, y, z), defined according to the coordinate system of an example spinning LIDAR acquisition model shown in FIGS. 6A and 6B.

Angular mode for predictive geometry coding may include modelling the position of M with three parameters (r, ϕ, i), which are computed as follows:

$$r = \sqrt{{x}^{2} + {y}^{2}} \\ ϕ = a tan 2 ( y , x ) \\ i = arg {min}_{j = 1 … N} \{ z + Ϛ ( j ) - r \times tan ( θ ( j ) ) \} ,$$

More precisely, angular mode for predictive geometry coding uses the quantized version of (r, ϕ, i), denoted (\tilde{r}, \tilde{ϕ}, i), where the three integers \tilde{r}, \tilde{ϕ} and i are computed as follows:

$$\tilde{r} = floor ( \frac{\sqrt{{x}^{2} + {y}^{2}}}{{q}_{r}} + {o}_{r} ) = hypot ( x , y ) \\ \tilde{ϕ} = sign ( a tan 2 ( y , x ) ) \times floor ( \frac{\vert a tan 2 ( y , x ) \vert}{{q}_{ϕ}} + {o}_{ϕ} ) \\ i = arg {min}_{j = 1 … N} \{ z + Ϛ ( j ) - r \times tan ( θ ( j ) ) \}$$

where
(qᵣ, oᵣ) and (q_{ϕ}, o_{ϕ}) are quantization parameters controlling the precision of \tilde{ϕ} and \tilde{r}, respectively.
sign(t) is the function that return 1 if t is positive and (−1) otherwise.
   |t| is the absolute value of t.

To avoid reconstruction mismatches due to the use of floating-point operations, the values of ç(i)_{i=1 . . . N} and tan(θ(i))_{i=1 . . . N} may be pre-computed and quantized as follows:

$$\tilde{z} ( i ) = sign ( Ϛ ( i ) ) \times floor ( \frac{\vert Ϛ ( i ) \vert}{{q}_{Ϛ}} + {o}_{Ϛ} ) \\ \tilde{t} ( i ) = sign ( Ϛ ( tan ( θ ( j ) ) ) \times floor ( \frac{\vert tan ( θ ( j ) \vert}{{q}_{θ}} + {o}_{θ} )$$

where
(q_{ç}, o_{ç}) and (q_{θ}, o_{θ}) are quantization parameters controlling the precision of \tilde{ç} and \tilde{θ}, respectively.

The reconstructed cartesian coordinates are obtained as follows:

$$\hat{x} = round ( \tilde{r} \times {q}_{r} \times app\_cos ( \tilde{ϕ} \times {q}_{ϕ} ) ) \\ \hat{y} = round ( \tilde{r} \times {q}_{r} \times app\_sin ( \tilde{ϕ} \times {q}_{ϕ} ) ) \\ \hat{z} = round ( \tilde{r} \times {q}_{r} \times \tilde{t} ( i ) \times {q}_{θ} - \tilde{z} ( i ) \times {q}_{Ϛ} ) ,$$

where app_cos(⋅) and app_sin(⋅) are approximation of cos(⋅) and sin(⋅). The calculations could be performed using a fixed-point representation, a look-up table, and linear interpolation.

The values for (\hat{x}, ŷ, z̅) may be different from (x, y, z) due to various reasons:
quantization
approximations
model imprecision
model parameters imprecisions

Let (rₓ, r_{y}, r_{z}) be the reconstruction residuals defined as follows:

$${r}_{x} = x - \hat{x} \\ {r}_{y} = y - \hat{y} \\ {r}_{z} = z - \hat{z}$$

In this method, G-PCC encoder 200 may proceed as follows:
Encode the model parameters \tilde{t}(i) and \tilde{z}(i) and the quantization parameters qᵣ q_{ç}, q_{θ} and q_{ϕ}
Apply a geometry predictive scheme to the representation (\tilde{r}, \tilde{ϕ}, i)
   A new predictor leveraging the characteristics of LIDAR could be introduced. For instance, the rotation speed of the LIDAR scanner around the z-axis is usually constant. Therefore, G-PCC encoder 200 may predict the current (j) as follows:

$$\tilde{ϕ} ( j ) = \tilde{ϕ} ( j - 1 ) + n ( j ) \times {δ}_{ϕ} ( k )$$

Where
   (δ_{ϕ}((k))_{k=1 . . . K} is a set of potential speeds the encoder could choose from. The index k could be explicitly written to the bitstream or could be inferred from the context based on a deterministic strategy applied by both G-PCC encoder 200 and G-PCC decoder 300, and
   n(j) is the number of skipped points which could be explicitly written to the bitstream or could be inferred from the context based on a deterministic strategy applied by both the encoder and the decoder. It is also referred to as “phi multiplier” later. Note, it is currently used only with delta predictor.
Encode with each node the reconstruction residuals (rₓ, r_{y}, r_{z})

G-PCC decoder 300 may proceed as follows:
Decode the model parameters \tilde{t}(i) and \tilde{z}(i) and the quantization parameters qᵣ q_{ç}, q_{θ} and q_{ϕ}
Decode the (\tilde{r}, \tilde{ϕ}, i) parameters associated with the nodes according to the geometry predictive scheme used by G-PCC encoder 200.
Compute the reconstructed coordinates (\hat{x}, ŷ, \hat{z}) as described above.
Decode the residuals (rₓ, r_{y}, r_{z})
   As discussed in the next section, lossy compression could be supported by quantizing the reconstruction residuals (rₓ, r_{y}, r_{z})
Compute the original coordinates (x, y, z) as follows

$$x = {r}_{x} + \hat{x} \\ y = {r}_{y} + \hat{y} \\ z = {r}_{z} + \hat{z}$$

Lossy compression may be achieved by applying quantization to the reconstruction residuals (rₓ, r_{y}, r_{z}) or by dropping points.

The quantized reconstruction residuals may be computed as follows:

$${\tilde{r}}_{x} = sign ( {r}_{x} ) \times floor ( \frac{\vert {r}_{x} \vert}{{q}_{x}} + {o}_{x} ) \\ {\tilde{r}}_{y} = sign ( {r}_{y} ) \times floor ( \frac{\vert {r}_{y} \vert}{{q}_{y}} + {o}_{y} )$$

$${\tilde{r}}_{z} = sign ( {r}_{z} ) \times floor ( \frac{\vert {r}_{z} \vert}{{q}_{z}} + {o}_{z} )$$

Where (qₓ, oₓ), (q_{y}, o_{y}) and (q_{z}, o_{z}) are quantization parameters controlling the precision of \tilde{r}ₓ, \tilde{r}_{y} and \tilde{r}_{z}, respectively.

Trellis quantization may be used to further improve the RD (rate-distortion) performance results. The quantization parameters may change at sequence/frame/slice/block level to achieve region adaptive quality and for rate control purposes.

The attribute coding, octree geometry coding, and predictive tree geometry coding techniques may be performed as intra prediction coding techniques. That is, G-PCC encoder 200 and G-PCC decoder 300 may code attribute and position data using only information from the frame of point cloud data being coded. In other examples, G-PCC encoder 200 and G-PCC decoder 300 may attributes, octree geometry, and/or predictive tree geometry using inter prediction techniques. That is, G-PCC encoder 200 and G-PCC decoder 300 may code attribute and position data using information from the frame of point cloud data being coded as well as information from previously-coded frames of point cloud data.

As described above, one example of predictive geometry coding uses a prediction tree structure to predict the positions of the points. When angular coding is enabled, the x, y, z coordinates are transformed to radius, azimuth and laserID and residuals are signaled in these three coordinates as well as in the x, y, z dimensions. The intra prediction used for radius, azimuth and laserID may be one of four modes and the predictors are the nodes that are classified as parent, grand-parent and great-grandparent in the prediction tree with respect to the current node. In one example, predictive geometry coding may be configured as an intra coding tool as it only uses points in the same frame for prediction. However, using points from previously-decoded frames (e.g., inter-prediction) may provide a better prediction and thus better compression performance in some circumstances.

For predictive geometry coding using inter-prediction, one technique involves predicting the radius of a point from a reference frame. For each point in the prediction tree, it is determined whether the point is inter predicted or intra predicted (indicated by a flag). When intra predicted, the intra prediction modes of predictive geometry coding are used. When inter-prediction is used, the azimuth and laserID are still predicted with intra prediction, while the radius is predicted from the point in the reference frame that has the same laserID as the current point and an azimuth that is closest to the current azimuth. Another example of this method enables inter prediction of the azimuth and laserID in addition to radius prediction. When inter-coding is applied, the radius, azimuth and laserID of the current point are predicted based on a point that is near the azimuth position of a previously decoded point in the reference frame. In addition, separate sets of contexts are used for inter and intra prediction.

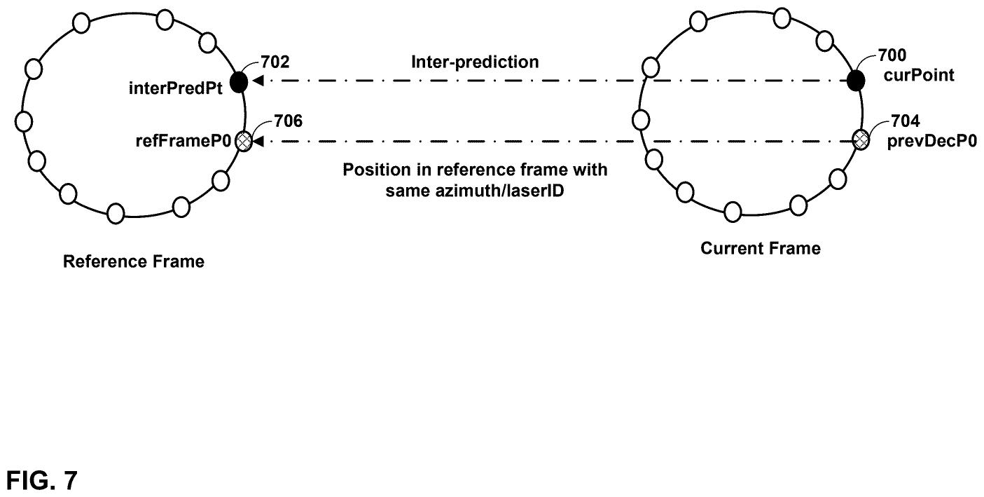

A method is illustrated in FIG. 7. FIG. 7 is a conceptual diagram illustrating an example of inter-prediction of a current point (curPoint) 700 in a current frame from a point (interPredPt) 702 in the reference frame. The extension of inter prediction to azimuth, radius, and laserID may include the following steps:
For a given point, choose the previous decoded point (prevDecPO) 704.
Choose a position point (refFramePO) 706 in the reference frame that has same scaled azimuth and laserID as prevDecPO 704.
In the reference frame, find the first point (interPredPt) 702 that has azimuth greater than that of refFramePO 706. The point interPredPt 702 may also be referred to as the “Next” inter predictor.

FIG. 8 is a block diagram illustrating an example of geometry encoding unit 250 of FIG. 2 in more detail. Geometry encoding unit 250 may include a coordinate transform unit 202, a voxelization unit 206, a predictive tree construction unit 207, an octree analysis unit 210, a surface approximation analysis unit 212, an arithmetic encoding unit 214, and a geometry reconstruction unit 216.

As shown in the example of FIG. 8, geometry encoding unit 250 may obtain a set of positions of points in the point cloud. In one example, geometry encoding unit 250 may obtain the set of positions of the points in the point cloud and the set of attributes from data source 104 (FIG. 1). The positions may include coordinates of points in a point cloud. Geometry encoding unit 250 may generate a geometry bitstream 203 that includes an encoded representation of the positions of the points in the point cloud.

Coordinate transform unit 202 may apply a transform to the coordinates of the points to transform the coordinates from an initial domain to a transform domain. This disclosure may refer to the transformed coordinates as transform coordinates. Voxelization unit 206 may voxelize the transform coordinates. Voxelization of the transform coordinates may include quantization and removing some points of the point cloud. In other words, multiple points of the point cloud may be subsumed within a single “voxel,” which may thereafter be treated in some respects as one point.

Prediction tree construction unit 207 may be configured to generate a prediction tree based on the voxelized transform coordinates. Prediction tree construction unit 207 may be configured to perform any of the prediction tree coding techniques described above, either in an intra-prediction mode or an inter-prediction mode. In order to perform prediction tree coding using inter-prediction, prediction tree construction unit 207 may access points from previously-encoded frames from geometry reconstruction unit 216. Dashed lines from geometry reconstruction unit 216 show data paths when inter-prediction is performed. Arithmetic encoding unit 214 may entropy encode syntax elements representing the encoded prediction tree.

Instead of performing prediction tree based coding, geometry encoding unit 250 may perform octree based coding. Octree analysis unit 210 may generate an octree based on the voxelized transform coordinates. Surface approximation analysis unit 212 may analyze the points to potentially determine a surface representation of sets of the points. Arithmetic encoding unit 214 may entropy encode syntax elements representing the information of the octree and/or surfaces determined by surface approximation analysis unit 212. Geometry encoding unit 250 may output these syntax elements in geometry bitstream 203. Geometry bitstream 203 may also include other syntax elements, including syntax elements that are not arithmetically encoded. Octree-based coding may be performed either as intra-prediction techniques or inter-prediction techniques. In order to perform octree tree coding using inter-prediction, octree analysis unit 210 and surface approximation analysis unit 212 may access points from previously-encoded frames from geometry reconstruction unit 216. Dashed lines from geometry reconstruction unit 216 show data paths when inter-prediction is performed.

Geometry reconstruction unit 216 may reconstruct transform coordinates of points in the point cloud based on the octree, the predictive tree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points.

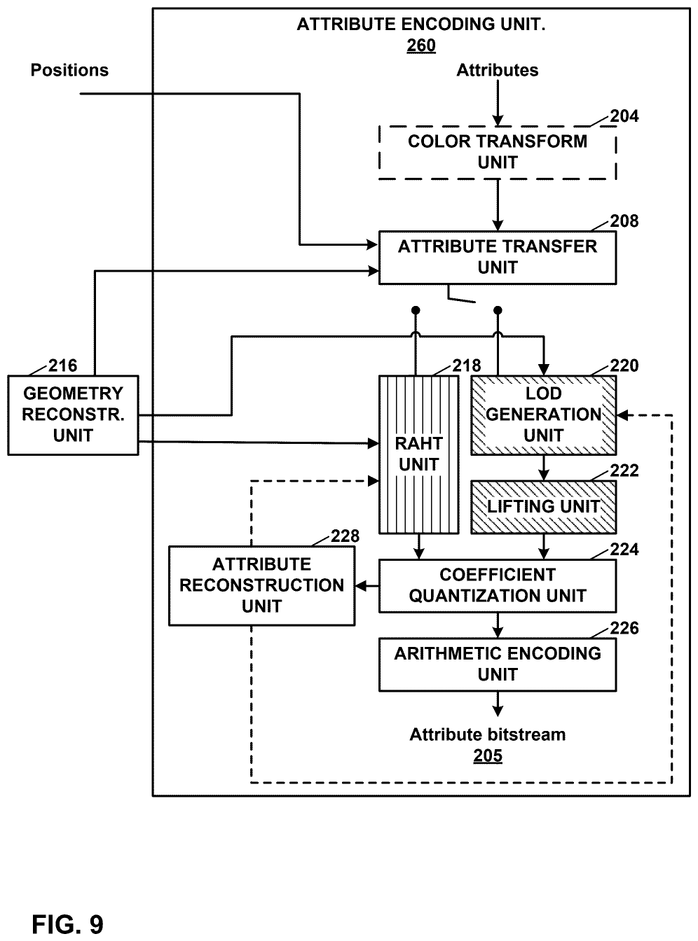

FIG. 9 is a block diagram illustrating an example of attribute encoding unit 260 of FIG. 2 in more detail. Attribute encoding unit 250 may include a color transform unit 204, an attribute transfer unit 208, an RAHT unit 218, a LoD generation unit 220, a lifting unit 222, a coefficient quantization unit 224, an arithmetic encoding unit 226, and an attribute reconstruction unit 228. Attribute encoding unit 260 may encode the attributes of the points of a point cloud to generate an attribute bitstream 205 that includes an encoded representation of the set of attributes. The attributes may include information about the points in the point cloud, such as colors associated with points in the point cloud.

Color transform unit 204 may apply a transform in order to transform color information of the attributes to a different domain. For example, color transform unit 204 may transform color information from an RGB color space to a YCbCr color space. Attribute transfer unit 208 may transfer attributes of the original points of the point cloud to reconstructed points of the point cloud. Attribute transfer unit 208 may use the original positions of the points as well as the positions generated from attribute encoding unit 250 (e.g., from geometry reconstruction unit 216) to make the transfer.

RAHT unit 218 may apply RAHT coding to the attributes of the reconstructed points. In some examples, under RAHT, the attributes of a block of 2×2×2 point positions are taken and transformed along one direction to obtain four low (L) and four high (H) frequency nodes. Subsequently, the four low frequency nodes (L) are transformed in a second direction to obtain two low (LL) and two high (LH) frequency nodes. The two low frequency nodes (LL) are transformed along a third direction to obtain one low (LLL) and one high (LLH) frequency node. The low frequency node LLL corresponds to DC coefficients and the high frequency nodes H, LH, and LLH correspond to AC coefficients. The transformation in each direction may be a 1-D transform with two coefficient weights. The low frequency coefficients may be taken as coefficients of the 2×2×2 block for the next higher level of RAHT transform and the AC coefficients are encoded without changes; such transformations continue until the top root node. The tree traversal for encoding is from top to bottom used to calculate the weights to be used for the coefficients; the transform order is from bottom to top. The coefficients may then be quantized and coded.

Alternatively or additionally, LoD generation unit 220 and lifting unit 222 may apply LoD processing and lifting, respectively, to the attributes of the reconstructed points. LoD generation is used to split the attributes into different refinement levels. Each refinement level provides a refinement to the attributes of the point cloud. The first refinement level provides a coarse approximation and contains few points; the subsequent refinement level typically contains more points, and so on. The refinement levels may be constructed using a distance-based metric or may also use one or more other classification criteria (e.g., subsampling from a particular order). Thus, all the reconstructed points may be included in a refinement level. Each level of detail is produced by taking a union of all points up to particular refinement level: e.g., LoD1 is obtained based on refinement level RL1, LoD2 is obtained based on RL1 and RL2, . . . LoDN is obtained by union of RL1, RL2, . . . RLN. In some cases, LoD generation may be followed by a prediction scheme (e.g., predicting transform) where attributes associated with each point in the LoD are predicted from a weighted average of preceding points, and the residual is quantized and entropy coded. The lifting scheme builds on top of the predicting transform mechanism, where an update operator is used to update the coefficients and an adaptive quantization of the coefficients is performed.

RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. G-PCC encoder 200 may output these syntax elements in attribute bitstream 205. Attribute bitstream 205 may also include other syntax elements, including non-arithmetically encoded syntax elements.

Like geometry encoding unit 250, attribute encoding unit 260 may encode the attributes using either intra-prediction or inter-prediction techniques. The above description of attribute encoding unit 260 generally describes intra-prediction techniques. In other examples, RAHT unit 215, LoD generation unit 220, and/or lifting unit 222 may also use attributes from previously-encoded frames to further encode the attributes of the current frame. In this regard, attribute reconstructions unit 228 may be configured to reconstruct the encoded attributes and store them for possible future use in inter-prediction encoding. Dashed lines from attribute reconstruction unit 228 show data paths when inter-prediction is performed.

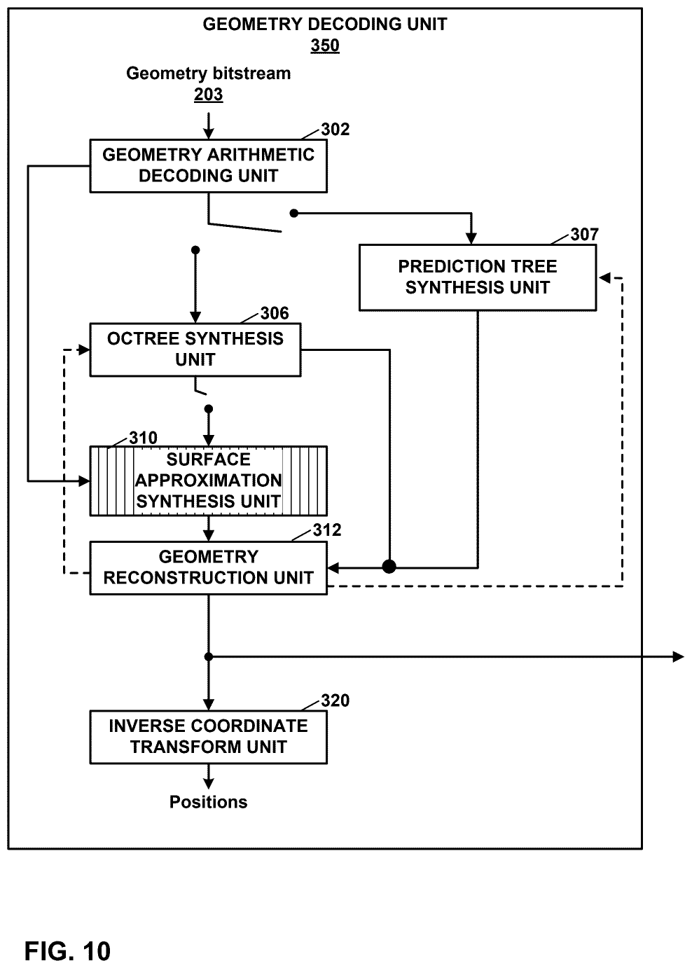

FIG. 10 is a block diagram illustrating an example geometry decoding unit 350 of FIG. 3 in more detail. Geometry decoding unit 350 may be configured to perform the reciprocal process to that performed by geometry encoding unit 250 of FIG. 8. Geometry decoding unit 350 receives geometry bitstream 203 and produces positions of the points of a point cloud frame. Geometry decoding unit 350 may include a geometry arithmetic decoding unit 302, an octree synthesis unit 306, a prediction tree synthesis unit 307, a surface approximation synthesis unit 310, a geometry reconstruction unit 312, and an inverse coordinate transform unit 320.

Geometry decoding unit 350 may receive geometry bitstream 203. Geometry arithmetic decoding unit 302 may apply arithmetic decoding (e.g., Context-Adaptive Binary Arithmetic Coding (CABAC) or other type of arithmetic decoding) to syntax elements in geometry bitstream 203.

Octree synthesis unit 306 may synthesize an octree based on syntax elements parsed from geometry bitstream 203. Starting with the root node of the octree, the occupancy of each of the eight children node at each octree level is signaled in the bitstream. When the signaling indicates that a child node at a particular octree level is occupied, the occupancy of children of this child node is signaled. The signaling of nodes at each octree level is signaled before proceeding to the subsequent octree level.

At the final level of the octree, each node corresponds to a voxel position; when the leaf node is occupied, one or more points may be specified to be occupied at the voxel position. In some instances, some branches of the octree may terminate earlier than the final level due to quantization. In such cases, a leaf node is considered an occupied node that has no child nodes. In instances where surface approximation is used in geometry bitstream 203, surface approximation synthesis unit 310 may determine a surface model based on syntax elements parsed from geometry bitstream 203 and based on the octree.

Octree-based coding may be performed either as intra-prediction techniques or inter-prediction techniques. In order to perform octree tree coding using inter-prediction, octree synthesis unit 306 and surface approximation synthesis unit 310 may access points from previously-decoded frames from geometry reconstruction unit 312. Dashed lines from geometry reconstruction unit 312 show data paths when inter-prediction is performed.

Prediction tree synthesis unit may synthesize a prediction tree based on syntax elements parsed from geometry bitstream 203. Prediction tree synthesis unit 307 may be configured to synthesize the prediction tree using any of the techniques described above, including using both intra-prediction techniques or inter-prediction techniques. In order to perform prediction tree coding using inter-prediction, prediction tree synthesis unit 307 may access points from previously-decoded frames from geometry reconstruction unit 312. Dashed lines from geometry reconstruction unit 312 show data paths when inter-prediction is performed.

Geometry reconstruction unit 312 may perform a reconstruction to determine coordinates of points in a point cloud. For each position at a leaf node of the octree, geometry reconstruction unit 312 may reconstruct the node position by using a binary representation of the leaf node in the octree. At each respective leaf node, the number of points at the respective leaf node is signaled; this indicates the number of duplicate points at the same voxel position. When geometry quantization is used, the point positions are scaled for determining the reconstructed point position values.

Inverse transform coordinate unit 320 may apply an inverse transform to the reconstructed coordinates to convert the reconstructed coordinates (positions) of the points in the point cloud from a transform domain back into an initial domain. The positions of points in a point cloud may be in floating point domain but point positions in G-PCC codec are coded in the integer domain. The inverse transform may be used to convert the positions back to the original domain.

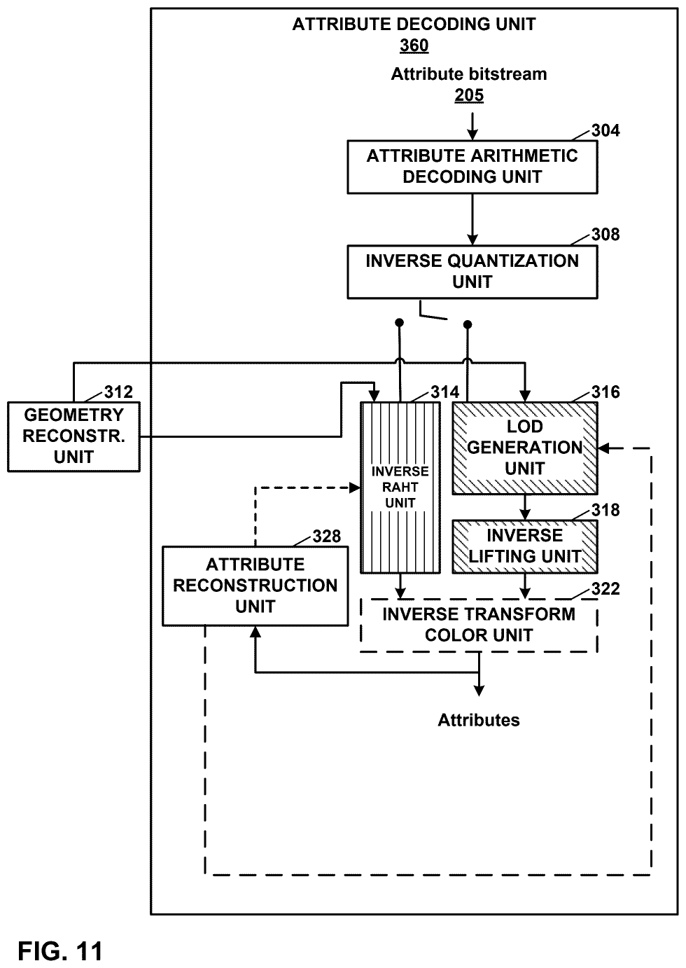

FIG. 11 is a block diagram illustrating an example attribute decoding unit 360 of FIG. 3 in more detail. Attribute decoding unit 360 may be configured to perform the reciprocal process to that performed by attribute encoding unit 260 of FIG. 9. Attribute decoding unit 360 receives attribute bitstream 205 and produces attributes of the points of a point cloud frame. Attribute decoding unit 356 may include an attribute arithmetic decoding unit 304, an inverse quantization unit 308, an inverse RAHT unit 314, an LoD generation unit 316, an inverse lifting unit 318, an inverse transform color unit 322, and an attribute reconstruction unit 328.

Attribute arithmetic decoding unit 304 may apply arithmetic decoding to syntax elements in attribute bitstream 205. Inverse quantization unit 308 may inverse quantize attribute values. The attribute values may be based on syntax elements obtained from attribute bitstream 205 (e.g., including syntax elements decoded by attribute arithmetic decoding unit 304).

Depending on how the attribute values are encoded, inverse RAHT unit 314 may perform RAHT coding to determine, based on the inverse quantized attribute values, color values for points of the point cloud. RAHT decoding is done from the top to the bottom of the tree. At each level, the low and high frequency coefficients that are derived from the inverse quantization process are used to derive the constituent values. At the leaf node, the values derived correspond to the attribute values of the coefficients. The weight derivation process for the points is similar to the process used at G-PCC encoder 200. Alternatively, LoD generation unit 316 and inverse lifting unit 318 may determine color values for points of the point cloud using a level of detail-based technique. LoD generation unit 316 decodes each LoD giving progressively finer representations of the attribute of points. With a predicting transform, LoD generation unit 316 derives the prediction of the point from a weighted sum of points that are in prior LoDs, or previously reconstructed in the same LoD. LoD generation unit 316 may add the prediction to the residual (which is obtained after inverse quantization) to obtain the reconstructed value of the attribute. When the lifting scheme is used, LoD generation unit 316 may also include an update operator to update the coefficients used to derive the attribute values. LoD generation unit 316 may also apply an inverse adaptive quantization in this case.

Furthermore, in the example of FIG. 11, inverse transform color unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, inverse color transform unit 322 may transform color information from the YcbCr color space to the RGB color space.

Attribute reconstruction unit 328 may be configured to store attributes from previously-decoded frames. Attribute coding may be performed either as intra-prediction techniques or inter-prediction techniques. In order to perform attribute decoding using inter-prediction, inverse RAHT unit 314 and/or LoD generation unit 316 may access attributes from previously-decoded frames from attribute reconstruction unit 328. Dashed lines from attribute reconstruction unit 328 show data paths when inter-prediction is performed.

The various units of FIGS. 8-11 are illustrated to assist with understanding the operations performed by G-PCC encoder 200 and G-PCC decoder 300. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

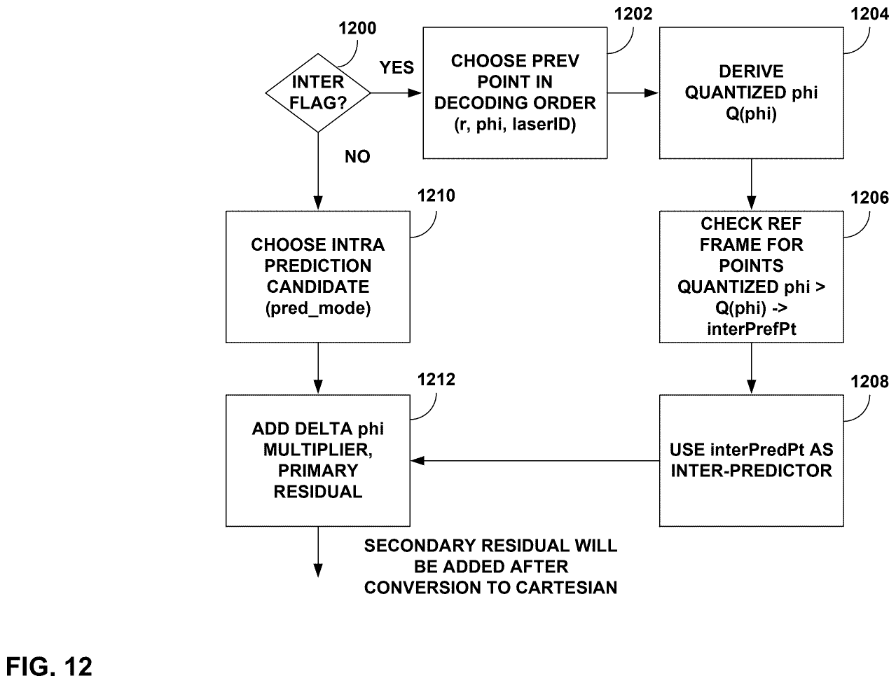

FIG. 12 is a flow diagram illustrating an example of decoding point cloud data. For example, FIG. 12 illustrates the decoding flow associated with the “inter_flag” that is signaled for every point. The example of FIG. 12 may be similar to examples available in InterEM-v3.0.

For example, in FIG. 12, G-PCC decoder 300 may determine whether current point is to be decoded using inter-prediction or intra-prediction based on a flag (1200). If inter-prediction (YES of 1200), G-PCC decoder 300 may choose previous point in decoding order in the current frame, including the radius component (r), azimuth component (phi), and laser identification component (laserID) (1202), and derive a quantized azimuth (e.g., phi) (1204). G-PCC decoder 300 may check a reference frame for points that have a greater quantized azimuth (e.g., the points are interPredPt) (1206), and use one or more of interPredPt as inter-predictor (1208). G-PCC decoder 300 may add delta azimuth multiplier to primary residual (1212).

If not inter-prediction (NO of 1200), G-PCC decoder 300 may choose intra-prediction candidate (e.g., pred_mode) (1210). G-PCC decoder 300 may add delta azimuth multiplier to primary residual (1212). G-PCC decoder 300 may add a secondary residual after a conversion back to Cartesian coordinates.

The following describes examples of additional predictor candidates. In the inter prediction method for predictive geometry described above for inter-prediction for predictive geometry coding, the radius, azimuth and laserID of the current point are predicted based on a point that is near the collocated azimuth position in the reference frame when inter coding is applied using the following steps: (a) for a given point, choose the previous decode point, (b) choose a position in the reference frame that has the same scaled azimuth and laserID as (a), and (c) choose a position in the reference frame from the first point that has azimuth greater than the position in b), to be used as the inter predictor point.

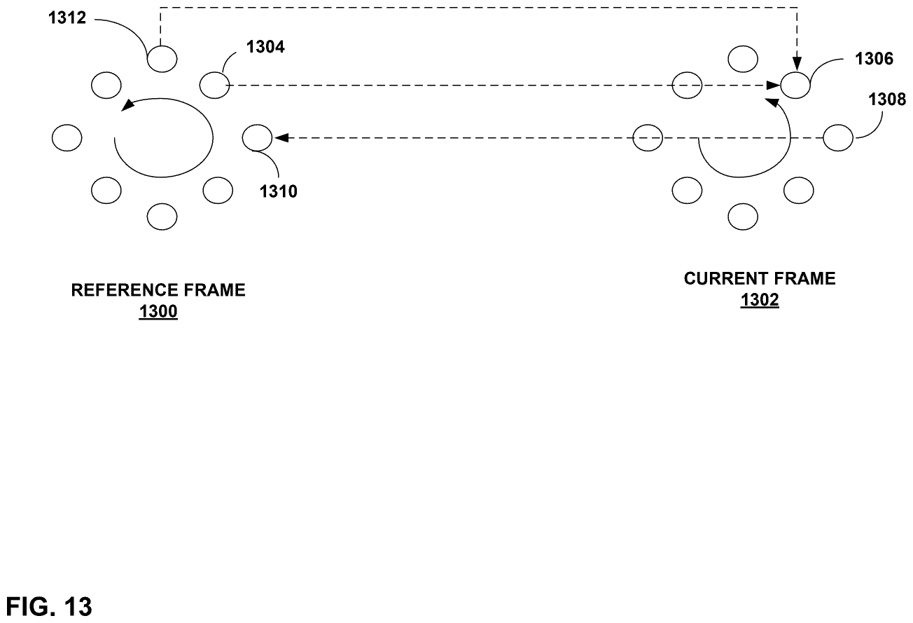

The example techniques add an additional inter predictor point that is obtained by finding the first point that has azimuth greater than the inter predictor point in c) as shown in FIG. 13. Additional signaling is used to indicate which of the predictors is selected if inter coding has been applied. The additional inter pred point is also referred to as the “NextNext” inter predictor.

For example, in FIG. 13, current frame 1302 includes current point 1306, with previous decoded point 1308. Point 1310 in reference frame 1300 is a reference point with same scaled azimuth and laserID as that for current frame 1302. Additional inter-prediction point 1312 of reference frame 1300 may also be used for inter-prediction of current point 1306.

The following describes improved inter-prediction flag coding. An improved context selection algorithm is applied for coding the inter prediction flag. The inter prediction flag values of the five previously coded points are used to select the context of the inter prediction flag in predictive geometry coding.

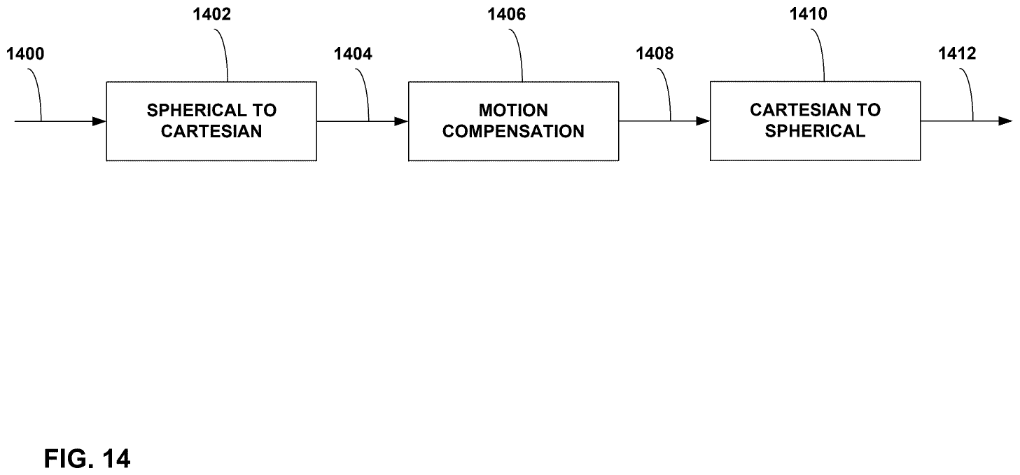

The following describes global motion compensation. When global motion (GM) parameters are available, inter prediction may be applied using a reference frame that is motion compensated using the GM parameters. The GM parameters may include rotation parameters and/or translation parameters. Typically, the global motion compensation is applied in the Cartesian domain. In some cases, the global motion compensation may also be conducted in the spherical domain. Depending on which domain the reference frame is stored, and which domain the reference frame is compensated, one or more of Cartesian to Spherical domain conversion, or Spherical to Cartesian domain conversion may be applied. For example, when the reference frame is stored in spherical domain, and the motion compensation is performed in the cartesian domain, the motion compensation process may involve one or more of the following steps illustrated in FIG. 14.

For instance, in FIG. 14, reference frame in spherical domain (1400) is input for spherical to cartesian domain conversion (1402). The output may be a reference frame in cartesian domain (1404). The reference frame in cartesian domain may be motion compensated (1406), and the output maybe a compensated reference frame in cartesian domain (1408). The compensated reference frame in cartesian domain (1408) may be input for cartesian to spherical domain conversion (1410). The output may be a compensated reference frame in spherical domain (1412).

In such cases, the compensated reference frame may be used for inter-prediction. Given a position (x, y, z) in cartesian coordinate system, the corresponding radius and azimuthal angle are calculated (floating point implementation) as follows (As in CartesianToSpherical conversion function):
int64_t r0=int64_t(std::round(hypot(xyz[0], xyz[1])));
auto phi0=std::round((atan2(xyz[1], xyz[0])/(2.0*M_PI))*scalePhi);
where, scalePhi is modified for different rate points in the lossy configuration; a maximum value of 24 bits is used for azimuth angle when coding the geometry losslessly. The fixed-point implementation of the azimuth is available in convertXyZToRpl function.

### Radius:

| | |
|---|---|
| Floating implementation | int64_tr0 = int64_t(std::round(hypot(xyz[0], |
| | xyz[1]))); |
| Fixed point | int64_t xLaser = xyz[0] << 8; |
| implementation | int64_t yLaser = xyz[1] << 8; |
| (in convertXyzToRpl) | int64_t r0 = isqrt(xLaser * xLaser + yLaser * |
| | yLaser) >> |
| | 8; |
| Floating implementation | auto phi0 = std::round((atan2(xyz[1], xyz[0]) / |
| | (2.0 * |
| | M_PI)) * scalePhi); |
| Fixed point | (*dst)[1] = (iatan2(yLaser, xLaser) + |
| implementation | 3294199) >> 8; |
| (in convertXyzToRpl) | |

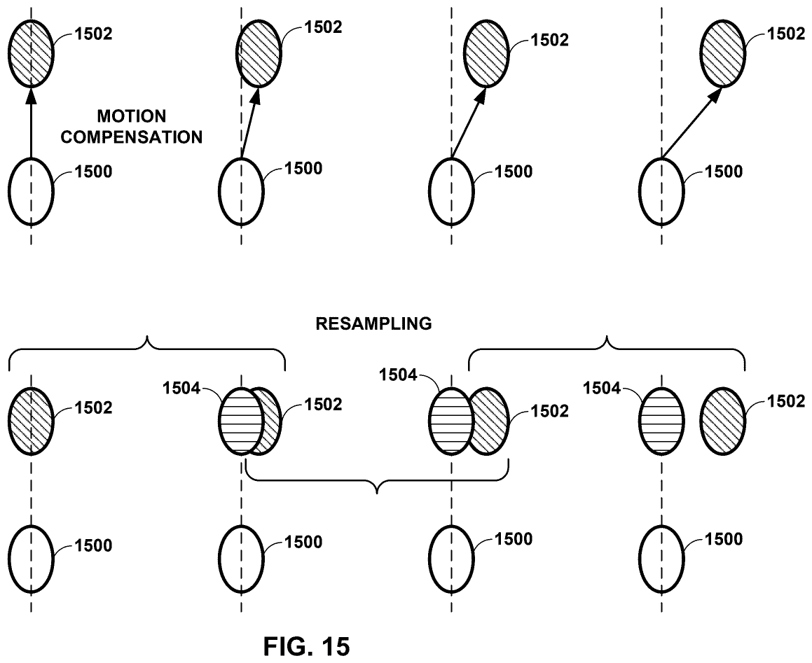

The following describes resampling of reference frame. When global motion compensation is applied, the azimuth position of the points are modified depending on the motion parameters. Therefore, resampling may be needed to align the azimuth points before and after compensation as illustrated in FIG. 15.

The non-filled ovals represent points 1500 in an uncompensated reference frame (e.g., a reference frame without, or prior to, any global motion compensation being applied). The diagonal-line-filled ovals represent points 1502 in a global motion compensated version of the reference frame. The horizontal-line-filled ovals represent resampled points 1504 of the global motion compensated version of the reference frame. Thus, points 1500 have no global motion compensation applied, points 1502 have global motion compensation applied, and points 1504 have global motion compensation and resampling applied. As can be seen, the application of global motion compensation may cause the azimuth position of one or more of points 1502 to become misaligned with respective points of points 1500. By resampling, G-PCC encoder 200 or G-PCC decoder 300 may realign points 1502 (e.g., shown as resampled points 1504) with their respective points 1500.

The resampling process may be applied for each point P in the uncompensated reference frame as follows:
a. Let A_ref be the azimuth value and L be the laser ID value associated with the point P.
b. If there is a point P1 in the (global motion-)compensated reference frame that has azimuth value equal to A_ref and laser ID equal to L, the radius of the point P is set equal to the radius of point P1.
c. Else, two points P2 and P3 are chosen in the (global motion-) compensated reference frame with laser ID L such that azimuth of the P2 is less than A_ref, azimuth of P3 is greater than A_ref. The radius of point P is set equal to a weighted interpolation of radii of points P2 and P3; the weights used for the interpolation is dependent on the difference between A_ref and the azimuth value of P2 and P3.

The resultant reference frame (obtained by resampling the uncompensated reference frame with radius values from the compensated reference frame), referred to as the resampled reference frame, is used to predict the inter prediction candidates. The two inter predictor candidates may therefore be indicated as [Res-Next, Res-NextNext], where the first part “Res” indicates that the candidates are obtained from the resampled reference frame and the second part “Next”/“NextNext” indicate the particular candidate in the reference frame, as described above.

The following describes additional candidates for inter prediction. In a modified inter predictor list four inter prediction candidates are specified as follows: [Zero-Next, Zero-NextNext, Glob-Next, Glob-NextNext].

The prefix “Zero” for the first two candidates indicates that the candidates are obtained directly from uncompensated reference frame (no motion compensation or resampling) and the prefix “Glob” for the last two candidates indicates that the candidates are obtained directly from global-motion-compensated reference frame.

The following describe flag for signaling resampling, gm to indicate 2/4 candidate. A flag was enabled to indicate whether resampling is enabled or not. Moreover, when global motion was disabled for the sequence, only two inter prediction candidates were allowed. Thus, the inter prediction candidates for predictive geometry coding were chosen as follows:
a. Global motion disabled:
   i. [Zero-Next, Zero-NextNext]
b. Global motion enabled
   i. Resampling enabled
      1. [Res-Next, Res-NextNext, Glob-Next, Glob-NextNext]
   ii. Resampling disabled
      1. [Zero-Next, Zero-NextNext, Glob-Next, Glob-NextNext]

The prefix “Res” for the first two candidates when both global motion and resampling is enabled indicates that the candidates are obtained from resampled reference frame.

The following describes spherical coordinate conversion. Spherical coordinate conversion is a technique used in G-PCC where geometry represented in the spherical coordinate system is used during attribute coding. Attribute coding typically involves the generation of levels of detail (for predicting/lifting transform), or generation RAHT tree (for RAHT transform), and both these methods make use of the geometry. When spherical coordinate conversion is not used, the geometry represented in Cartesian coordinates is used for attribute coding; a Morton scan order is chosen for parsing the points. For sparse data, such as those obtained using LIDAR sensors, using the Cartesian coordinates results in sub-optimal relationship of points in the Morton order. As the spherical coordinate system uses the sensor scan characteristics, geometry converted to the spherical coordinate system provides a much more efficient representation of the points. Morton scan order in this domain provides more meaningful relationship of points, and this improves the efficiency of coding attributes. Typically, spherical coordinate conversion is used only when the angular mode (used to code the geometry) is enabled.

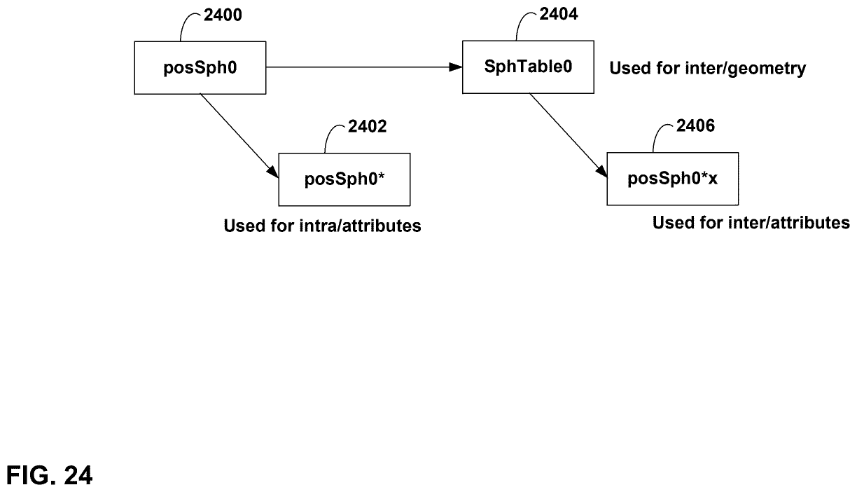

The spherical coordinate representation that is used is for attribute coding (posSph0*) is obtained by applying an offset and scale to the actual spherical coordinate representation of the geometry (posSph0). In one or more examples, posSph0 may be considered as a reference point cloud frame (e.g., the coordinate representation of the geometry of the reference point cloud frame). In some examples, G-PCC encoder 200 and G-PCC decoder 300 may apply a process (e.g., apply an offset and scale) to the reference point cloud frame (e.g., to the coordinate representation of the geometry of the reference point cloud frame, such as posSph0) to generate a processed frame (e.g., posSph0*) that is used for encoding or decoding attribute data of points. In one or more examples, posSph0* may be used to for encoding or decoding (e.g., intra-prediction or inter-prediction) attribute data of points of the reference frame, and another processed frame may be used for inter-prediction encoding or decoding attribute data of points of the current point cloud frame, as described below with respect to FIG. 24.

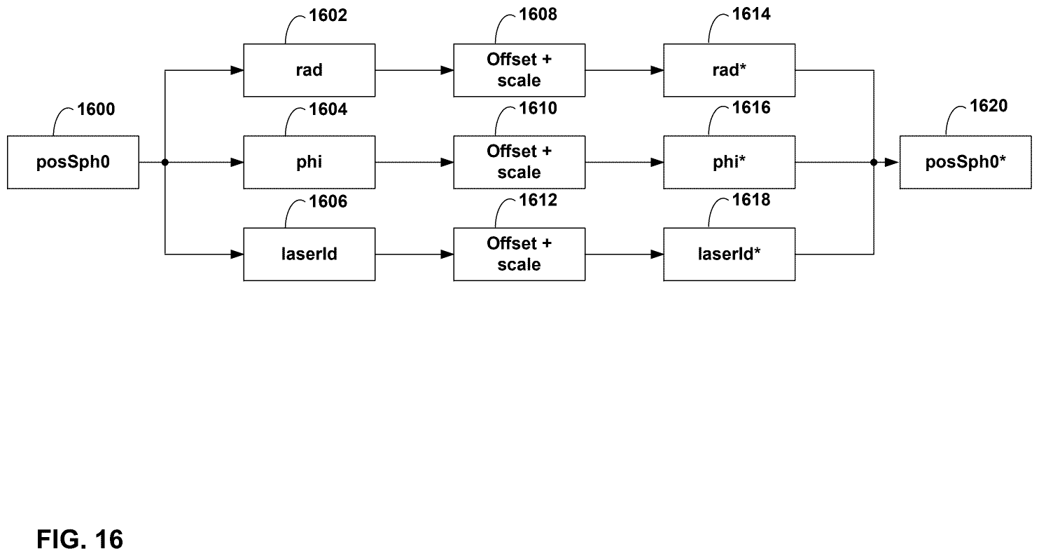

As applying offset/scale is a linear transformation. FIG. 16 illustrates how the radius (rad), azimuth (phi) and laser ID (laserId) that together form the spherical representation posSph0 are transformed to rad*, phi* and laserId* of the spherical representation posSph0* that is used for attribute prediction. The offset and scale values for each dimension is signaled in the attribute parameter set (APS).

For example, in FIG. 16, reference point cloud frame (posSph0) 1600 is in spherical coordinates and includes radius (rad) component 1602, azimuth (phi) component 1604, and laser identification (laserId) component 1606. As described reference point cloud frame 1600 may be used to refer to the coordinate representation of the geometry of the reference point cloud frame 1600. Each of rad 1602, phi 1604, and laserID 1606 may go through an offset and scale process 1608, 1610, and 1612, respectively. The result may be a processed frame (posSph0*) 1620 having radius (rad*) component 1614, azimuth (phi*) component 1616, and laser identification (laserId*) component 1618. In one or more examples, posSph0* may be used for intra-prediction of attribute data of points in the reference frame, but another processed frame may be used for inter-prediction of attribute date of points in a current frame.

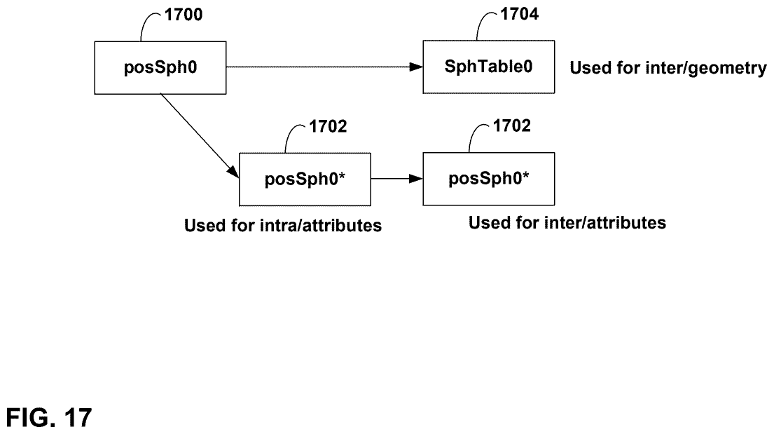

The following describes examples of inter-prediction buffers. Some example techniques use two reference frame buffers for the same reference frame. One buffer is used for the inter prediction of geometry, and another buffer is used for the inter prediction of attributes, as illustrated in FIG. 17. The contents of the two buffers are not identical.

For example, consider a reference frame 0. The reconstructed spherical coordinates of frame 0, posSph0 1700 is used to generate posSph0* 1702 using spherical coordinate conversion, as described above with respect to FIG. 16. In some techniques, this representation, posSph0* is used both for intra attribute prediction and inter attribute prediction. That is, posSph0* 1702 is used both for intra-prediction encoding and decoding attribute data of points of the reference point cloud frame (e.g., reference frame 0), and inter-prediction encoding and decoding attribute data of points of the current point cloud frame. As described in more detail, this may be inefficient from memory storage perspective, as posSph0* 1702 is retained frame-to-frame (e.g., kept in storage after completion of encoding or decoding reference frame 0 to the start of encoding or decoding the current frame).

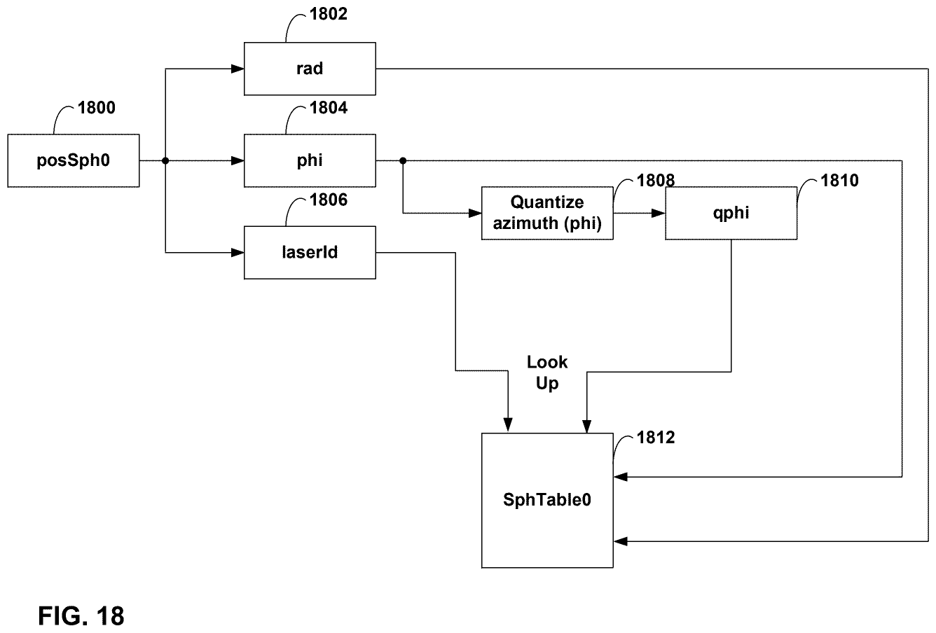

In parallel, posSph0 is also used to generate a spherical table SphTable0 1704 that is used for inter-prediction of geometry by the following method illustrated in FIG. 18. SphTable0 1704 may be considered as a first level processed frame. For instance, G-PCC encoder 200 and G-PCC decoder 300 may apply a first process to a reference point cloud frame (e.g., posSph0 1700) to generate a first level processed frame (e.g., SphTable0 1704). One example of the first process is illustrated in FIG. 18.

For example, in FIG. 18, G-PCC encoder 200 and G-PCC decoder 300 may apply a first process to a reference point cloud frame (posSph0) 1800 to generate a first level processed frame (SphTable0) 1812. For instance, the reference point cloud frame 1800 may include radius (rad) component 1802, azimuth (phi) component 1804, and laser identification (laserId) component 1806. G-PCC encoder 200 and G-PCC decoder 300 may quantize (1808) the azimuth component 1804 to generated quantized azimuth component 1810.

For each of a plurality of quantized azimuth components 1810 and a for a laser identification component 1806, G-PCC encoder 200 and G-PCC decoder 300 may store a radius component 1802 and an azimuth component 1804 for “k” number of points of the reference point cloud frame 1800 associated with the laser identification component 1806 to generate SphTable0 1812. As illustrated, a quantized azimuth qPhi 1810 and laserID 1806 are used as lookup values in a spherical table (SphTable0 1812) that stores the points in the spherical coordinates. That is, each of the plurality of quantized azimuth components 1810 is an index to the table (SphTable0 1812), along with the laser identification component 1806, and the table (SphTable0 1812) is at least a portion of the first level processed frame.

There may be certain issues with technique for coding a current frame of point cloud data. Some implementations of inter-prediction of predictive geometry use two reference frame buffers for the same reference frame in inter prediction: one buffer for geometry and one buffer for attributes. The buffers are not identical and hence they cannot be re-used. For instance, in FIG. 17, SphTable0 1704 and posSph0* 1702 are stored in two different buffers, and are maintained from frame-to-frame (e.g., from a reference frame to a current frame). This increases the cost to store inter-prediction frames. Using less buffer space would be more beneficial.

One or more example techniques described in this disclosure may be applied independently or in a combined way.

An indication to the G-PCC decoder 300 that the reference frame used for geometry inter prediction is obtained by applying a first process (or Process 1) on the reference frame. To distinguish the reference frames before and after processing, the following nomenclature is used:
a. Unprocessed reference frame (UPRF)—this is the reference that has not been processed; this reference frame may be in Cartesian coordinates or spherical coordinates (for geometry). In some cases, the UPRF may be present in both the Cartesian and spherical coordinates (as in both representations may be present). The unprocessed Cartesian reference frame may be output from the decoder. In some cases (e.g., spherical coordinate conversion), the UPRF in spherical coordinate may be transformed into another reference frame (e.g., using a scale and offset)—this transformed reference frame is used to derive the attributes of the reference frame. In this case, the transformed reference frame will also be referred to as the UPRF (or transformed UPRF), because from the point of view of inter-prediction, the transformed frame (after the reference frame has been decoded) has not been processed.
b. Processed reference frame (PRF)—one or more techniques in this disclosure may be used to derive the PRF from the UPRF. The PRF may be used for inter-prediction, or may be further processed for inter prediction of current and subsequent frame in decoding order. A second processed reference frame, PRF-A, may be generated from PRF; PRF-A may be used to code the attributes. PRF may be referred to as a first level processed frame, and PRF-A may be referred to as a second level processed frame. Examples of PRF (e.g., a first level processed frame) include the SphTable0, and examples of PRF-A (e.g., a second level processed frame) include posSph0*x that is generated from SphTable0.

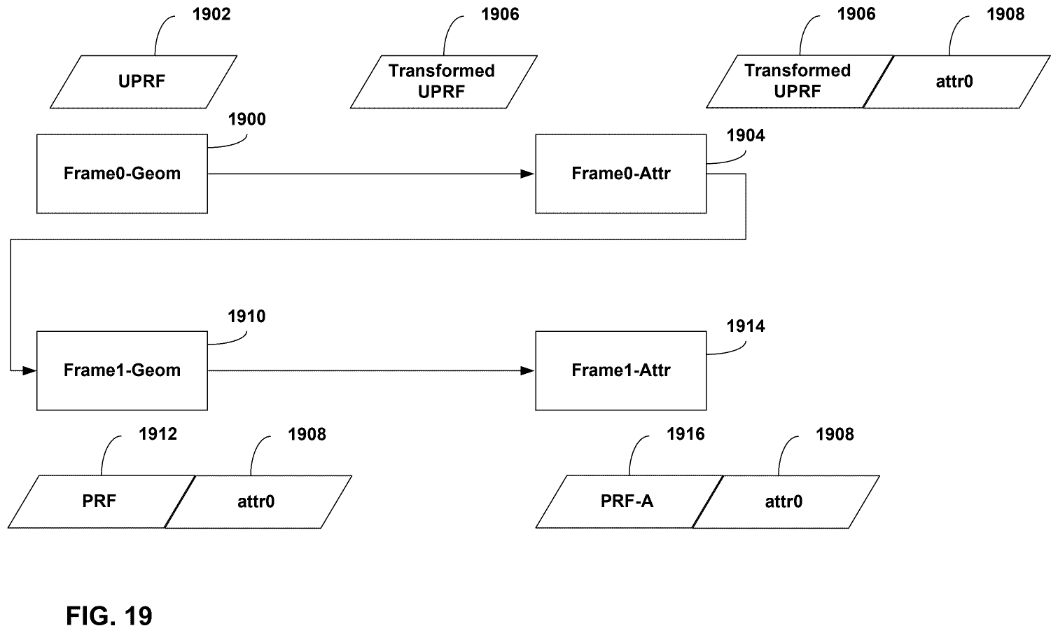

The FIGS. described below show the various terms defined above, such as in FIG. 19. The parallelogram blocks indicate data/buffer(s), and rectangles indicate processes. When the parallelogram is on the immediate left (above or below) of a rectangle, it is an input to the rectangle. When the parallelogram is on the immediate right (above or below) of a rectangle, it is an output of the rectangle.

For instance, for frame 0, the geometry data of points, stored as UPRF 1902, may be processed through Frame0-Geom 1900 using scale and offset and stored as transformed UPRF 1906. The attributed data for frame 0 may be processed through Frame0-Attr 1904 to generate attr0 1908 that is associated with Transformed UPRF 1906.

For frame 1, transformed UPRF 1906 may be processed through Frame1-Geom 1910 to generate PRF 1912 associated with attor0 1908. For the attribute, frame 1 may be processed through Frame1-Attr 1914 to generate PRF-A 1916 that is associated with attr0.

A first process may include generating a PRF from a UPRF. One or more steps may be involved in this generation. Some example steps, or processes, of this generation are listed below. These steps may be applied individually or combined in some fashion.

Quantization may be applied on points of the UPRF 1906 to obtain the PRF 1912. The quantization may be applied on the geometry, attributes, or both. More details about quantization are provided further below. In some cases, when coordinates are quantized, a subset of points that have the same quantized azimuth value may be dropped/not included.

An offset and scale may be applied to the geometry, attributes, or both to derive the processed frame from the unprocessed frame. A filtering operation may be applied to the geometry, attributes, or both to derive the processed frame from the unprocessed frame. The processed frame may be copied from the unprocessed frame.

Subsample/drop points—one or more points in the UPRF may be skipped/not included to obtain the PRF. In some cases, this process is also referred as quantization.

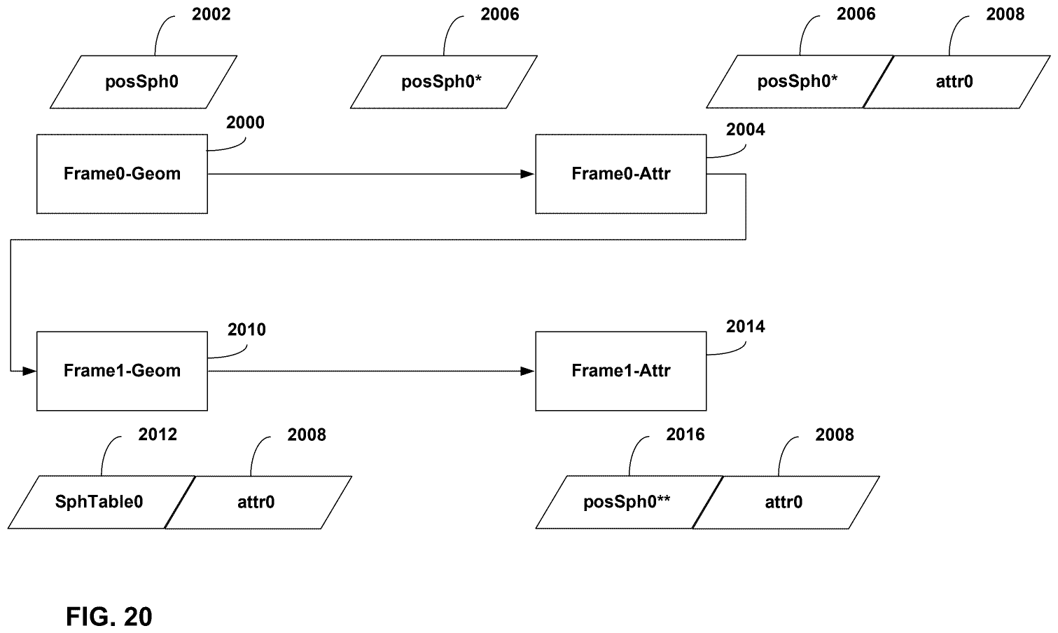

In some examples, the PRF 1912 may be generated and represented as a table indexed by laser ID and a quantized value of azimuth, where each occupied entry in the table contains one point (coordinates and attributes). That is, one example of PRF 1912 is SphTable0 2012 of FIG. 20, and is generated using the example techniques described above with respect to FIG. 18. As described, SphTable0 1812 is indexed using laserId 1806 and quantized phi 1810.

A third process may be defined to specify how the entries are populated in the PRF. The third process is described below, and the second process is described further below after description of the third process.

In some examples, the PRF may be generated and represented as a table indexed by laser ID and a quantized value of azimuth, where each occupied entry in the table may contain one or more points (coordinates and attributes). Each entry may thus contain a list or array of points. For instance, as described above, with respect to FIG. 18, in some examples, SphTable0 1812 of FIG. 18 may include k number of points, where k is greater than or equal to 1. Similarly, SphTable0 2012 of FIG. 20, as described above, may include k number of points where k is greater than or equal to 1.

One or more syntax elements may be signaled that allow to specify whether the entries in the table may have more than one entry, and if there may be more than one entry, the maximum number of points in each table entry (e.g., when the signaled syntax element maxPointsPerEntryMinus1 has value 0), at most one point may be present in each entry; when the signaled syntax element maxPointsPerEntryMinus1 has value n (n>0), then at most (n+1) points may be present in each entry. SphTable0 1812 or 2012 including “k” number of points may be defined by the maxPointsPerEntryMinus1 syntax element, but in some examples, there maxPointsPerEntryMinus1 may be preset instead of signaled and received.

As one example, when the maximum number of points per entry is one (e.g., k=1), the third process may specify the following:
a. If there is only one point with a particular index (i.e., same laser ID and quantized azimuth value), then that point is added as the table entry for that index.
b. If there are more points than one point (first set) that have the same index (i.e., same laser ID and quantized azimuth value), the first point that is processed/coded in the first set is included as the table entry for that index.
c. In some cases, if there are more points than one point (first set) that have the same index (i.e., same laser ID and quantized azimuth value), the point that has the smallest radius values in the first set is included as the table entry for that index.

As another example, when the maximum number of points per entry is greater than one (e.g., k>1), the third process may specify the following (say that each table entry may have at most n+1 points):
a. If there is only one point with a particular index (i.e., same laser ID and quantized azimuth value), then that point is added as the table entry for that index.
b. If there are more points than one point (first set) that have the same index (i.e., same laser ID and quantized azimuth value), at most the first (n+1) points that are processed/coded in the first set are included as the table entry for that index (in the same order as they were processed).
c. In some cases, if there are more than one point (first set) that have the same index (i.e., same laser ID and quantized azimuth value), at most (n+1) points that have smallest radius are included as the table entry for that index (in non-decreasing order of radius).
d. In some cases, if there are more points than one point (first set) that have the same index (i.e., same laser ID and quantized azimuth value), at most the first (n+1) points that are processed/coded in the first set are included as the table entry for that index (in the same order as they were processed). If the point P with the smallest radius in the first set is included in the first (n+1) points, then point P is put as the first point in the table entry and rest of the points are shifted right as needed. Otherwise (point P with the smallest radius in the first set may not be included in the first (n+1) points), then (a) last point in the table entry is removed, (b) rest of the points are moved right by one position, and (c) point P is added as the first point in the entry.

Intermediate buffers (e.g., used in the generation of resampled reference picture) may also be used entry with more than one point.

The indication to apply the first process to obtain the PRF may involve signaling a syntax element in the bitstream. This syntax element may be a flag indicating that the first process is to be applied, and/or a mode value indicating/specifying which type of first process is to be applied (e.g., quantization, offset+scale, filtering, subsampling, etc.). In some examples, the first process may be applied when inter prediction is enabled (thus relying on a syntax element indicating inter prediction rather than an explicit syntax element.). In some examples, a default mode may be chosen by G-PCC encoder 200 and G-PCC decoder 300.

That is, G-PCC encoder 200 and G-PCC decoder 300 may apply a first process to a reference point cloud frame to generate a first level processed frame. The first process may be UPRF to PRF conversion. For instance, if the reference point cloud frame (e.g., UPRF) is posSph0 (e.g., the coordinate representation of the geometry of the reference point cloud frame), then the PRF may be SphTable0 generated using the example techniques of FIG. 18.

In a second process, the PRF (e.g., first level of processed frame or SphTable0) generated for geometry may not be directly used for inter-prediction of attributes. A second process may be applied to the PRF to generate a different processed reference frame PRF-A (e.g., second level of processed frame, also called posSph0** or posSph0*x) for attribute inter prediction (with the suffix ‘A’ to indicate attribute).

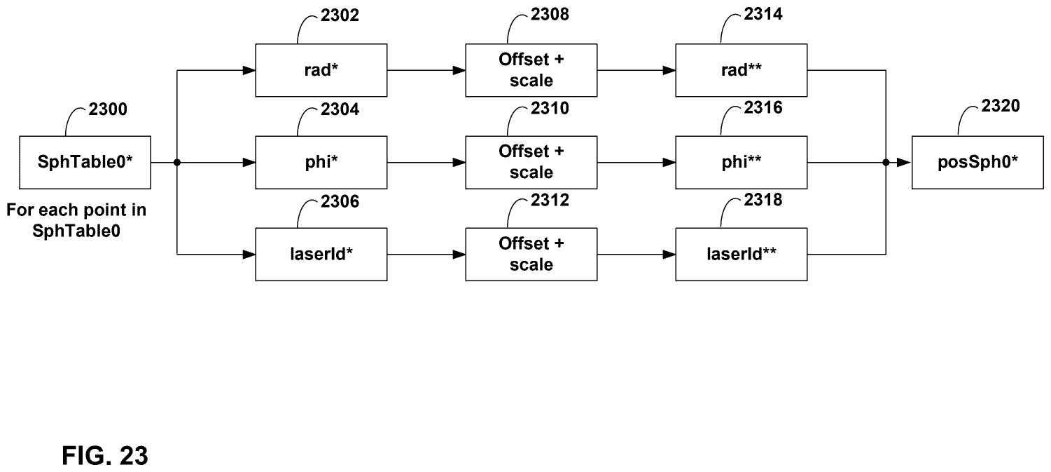

That is, G-PCC encoder 200 and G-PCC decoder 300 may apply a second process to the first level processed frame (e.g., PRF or SphTable0) to generate a second level processed frame (e.g., posSph0**). The second process to generate posSph0** may be similar to the example illustrated in FIG. 16 or described below in more detail with respect to FIG. 23. For instance, G-PCC encoder 200 and G-PCC decoder 300 may, for each point in the first level processed frame, apply an offset and a scale to one or more of a radius component, an azimuth component, and a laser identification component to generate the second level processed frame.

G-PCC encoder 200 and G-PCC decoder 300 may inter-prediction encode or decode geometry data of points of a current point cloud frame using the first level processed frame. G-PCC encoder 200 and G-PCC decoder 300 may inter-prediction encode or decode attribute data of points of the current point cloud frame using the second level processed frame.

In one or more examples, the second level processed frame may also include coordinate information. In such examples, it is this coordinate information that is used for encoding or decoding attribute data. For instance, the actual attribute data (e.g., color, reflectance, etc.) may be associated with the coordinate information of points in the second level processed frame. Accordingly, both the first level processed frame and the second level processed frame may both include coordinate information, but the coordinate information in the first level processed frame may be used for inter-prediction encoding or decoding geometry data, and the coordinate information in the second level processed frame may be used for inter-prediction encoding or decoding attribute data.

Use of PRF (e.g., first level processed frame) to generate PRF-A (e.g., second level processed frame) may have following benefit: the size of PRF may not be as large as the UPRF, and thus storing only PRF may be beneficial for storage. When PRF is used to generate PRF-A, this storage benefit is maintained; however, there may be a drop in the efficiency of inter-prediction. If UPRF (e.g., posSph0) was used to generate PRF-A, both UPRF and PRF may be stored during inter prediction of subsequent frames. For instance, as illustrated in FIG. 17, both SphTable0 1704 and posSph0* are maintained for inter-prediction of subsequent frames. With the example techniques, because posSph0** (e.g., the second level processed frame used for inter-prediction of attribute data) is generated from SphTable0 (e.g., the first level processed frame used for inter-prediction of geometry data), the amount of data that is stored may be reduced frame-to-frame.

In some examples, PRF-A may be generated using a second process from UPRF. In some examples, the second process may correspond to the first process. For example, the second process may be specified to reverse the effect of the first process. The first process may not be a reversible process; in such cases, the second process may apply steps that reverse the effect of the first process to certain extent. However, in the general case, the second process may not correspond to a first process and be specified independently.

One or more parameters associated with the first process may be signaled in the bitstreams. The number of parameters signaled may be determined based on the type of first process applied.

When the first process involves a scale and offset, a scale and an offset may be signaled. When the first process involves a quantization, a quantization scale value may be signaled; in some cases, a value may be signaled and the quantization scale value may be derived from the value.

Parameters may be signaled in a parameter set (SPS, APS, GPS, etc.) or the slice header or another syntax element in the bitstream. The parameters may be signaled/applied at a per-frame basis or a per-sequence basis. That is, when applied on a per-frame basis, the parameters may be signaled for each frame and when applied on a per-sequence basis, the parameters may be signaled once for each sequence.

In some examples, one or parameters may also be signaled for the second process. When the second process is associated with the first process, parameters of the second process may be derived from the parameters of the first process. Parameters for the first and second process may be different for each coordinate. In this case, separate coordinates may be signaled. In some examples, one or more parameters may be inferred from other signaled parameters/syntax elements. One or more techniques mentioned in this application may also apply to multiple reference frames, and bidirectional prediction.

Signal an indication that no quantization is to be applied to the reference frame; this quantization may refer to quantization of points coordinates, or subsampling of points, or both. Signal an indication that points that are not included in the generation of PRF be stored as a list, which may be used for later process (e.g., generation of PRF-A).

Although the generated reference frames (e.g., processed frame, first level processed frame, and/or second level processed frame) above are mentioned to be used for inter-prediction, the reference frames may also be used for other coding modes, or more generally coding of one or more other frames.

The following describes example techniques for implementing several methods described in this disclosure. In some examples, geometry is coded using predictive geometry coding and inter prediction is enabled for subset of frames. Angular mode is enabled (i.e., laser parameters of the sensor are available) and spherical coordinate conversion is enabled.

FIG. 20 shows the overall generation of the UPRF and PRF in the coding of frames. Consider two frames Frame 0 and Frame 1. Frame0-Geom 2000 indicates coding of Frame 0 geometry, Frame0-Attr 2004 indicates coding of Frame 0 attribute, Frame1-Geom 2010 indicates coding of Frame 1 geometry, and Frame1-Attr indicates coding of Frame 1 attributes.

The parallelograms depict data/buffer(s) used as inputs by the blocks or as output of the block. Only the data parallelograms that are relevant for this example are depicted in FIG. 20. There may be other input/output to each block.

Frame0-Geom 2000 depicts coding of geometry of frame 0. The output of Frame0-Geom 2000 includes the reconstructed spherical coordinate representation of the geometry, posSph0 (UPRF) 2002. The transformed spherical coordinate representation posSph0* (transformed UPRF, or also called UPRF) 2006 is obtained from the spherical coordinate representation posSph0.

Frame0-Attr 2004 depicts coding of attributes of frame 0. The input to Frame0-Attr 2004 is the transformed spherical coordinate representation posSph0*. The output of this block includes the transformed spherical coordinate representation of the geometry, posSph0* 2006, and the corresponding attributes attr0 2008. In this example, posSph0* 2006 will be the UPRF for Frame 1.

The spherical table representation of the reference frame SphTable0 2012 is the PRF used for the geometry of Frame 1. It is derived from posSph0* using the first process described above, such as that of FIG. 18.

Frame1-Geom 2010 depicts coding of geometry of frame 1 using inter-prediction. The input of Frame1-Geom 2010 includes the spherical table representation of the reference frame SphTable0.

The spherical coordinate representation of the reference frame posSph0** 2016 is the PRF (referred as PRF-A) used for the attributes of Frame 1. It is derived from SphTable0 using the second process described above.

Frame1-Attr 2014 depicts coding of attributes of frame 1 using inter prediction. The input to Frame1-Attr2014 includes the spherical coordinate representation posSph0** 2016.

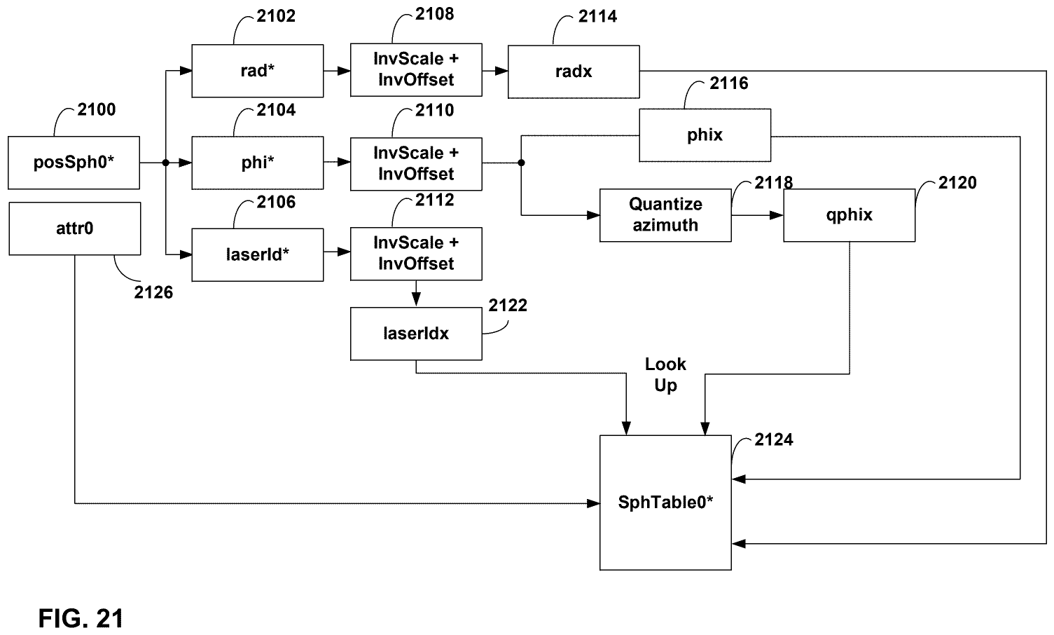

The following is an example of implementing a first process (e.g., UPRF to PRF), as illustrated in FIG. 21. FIG. 21 details a method to generate a PRF SphTable0* from a transformed UPRF SphTable0* 2124 by applying a scale and offset. The UPRF is stored as a spherical table (e.g., SphTable0* 2124), with laser IDx 2122 and the quantized azimuth 2120 being used as the lookup parameters; the radius, azimuth and attribute are stored as entries in the table SphTable0* 2124.

The spherical coordinate representation posSph0*2100 comprises of radius (rad*) 2102, azimuth (phi*) 2104 and laser ID (laserID*) 2106. The posSph0* 2100 may be obtained by applying an offset and scale on the reconstructed spherical coordinates (scale and offset may be different for different coordinates). In this example, first process may involve a scale InvScale and offset InvOffset 2108, 2110, and 2112, respectively, to obtain the radius radx 2114, azimuth phix 2116 and laser ID laserIdx 2122 in the original representation. A quantized azimuth qPhix 2120 may be derived from the azimuth Phix 2116. The spherical lookup table (SphTable0*) 2124 may be generated with qPhix 2120 and laserIdx 2122 as the two coordinates for lookup, and the point radx 2114, phix 2116, laserIdx 2122 and attributes are stored as entries (laserIdx need not be stored as it is available as one of the indices of the bins of the table.).

In the above, the terms InvScale and InvOffset are used, but scale and offset are used further above when describing example techniques of this disclosure. That is because this scale and offset themselves may be considered as the inverse of the process for spherical coordinate conversion. In general, InvScale and InvOffset may be considered as some numbers used for performing the example techniques.

In some examples, the parameters used in the first process may be derived from the parameters used in the spherical coordinate conversion, or other syntax elements in the bitstream.

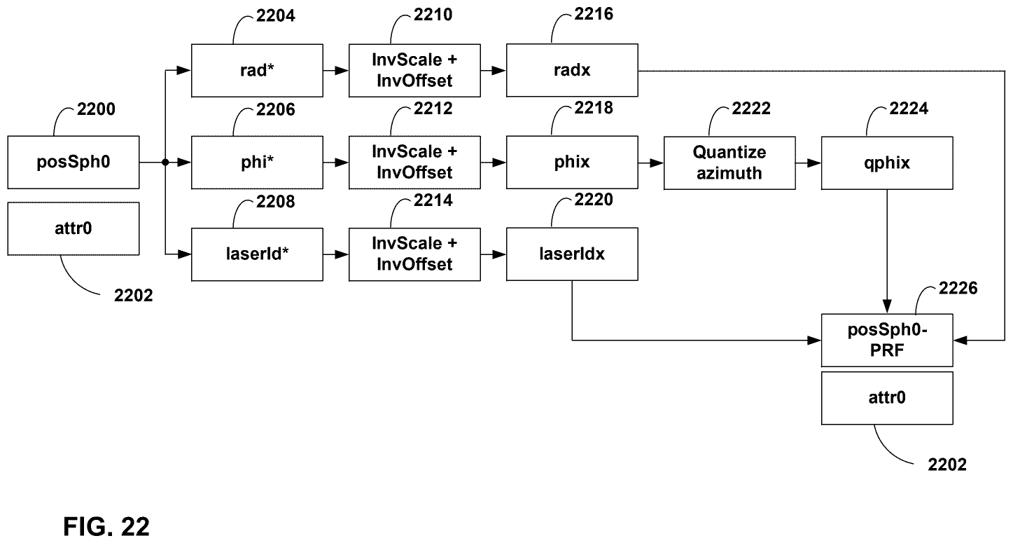

The following describes an example of a method to generate a PRF from a transformed PRF by applying a scale and offset operation, followed by a quantization of the azimuth. The output of this process is a UPRF, referred to as posSph0-PRF, as illustrated in FIG. 22.

In this example, the first process may involve a scale and offset to obtain the radius Radx 2210, azimuth Phix 2218 and laser ID laserIdx 2220 in the original representation using InvScale and InvOffset 2210, 2212, and 2214, respectively, from rad* 2204, phi* 2206, and laserId* 2208 of posSph0 2200. A quantized azimuth qPhix 2224 may be derived from the azimuth Phix 2218. The UPRF posSph0-PRF 2226 may be obtained by storing each point as Radx 2216, qPhix 2224 and laserIdx 2226 (and attributes 2202). In some examples, this UPRF is not stored in the spherical table fashion.

The following describes an example of a method to generate a second PRF, PRF-A, that may be used in the inter prediction of attributes. As described above, the PRF may be generated from UPRF using a first process; this PRF (e.g., first level processed frame) may be used for coding the geometry. For coding the attributes, a second processed frame, PRF-A (e.g., second level processed frame), may be derived from PRF.

In this example, PRF-A is generated from PRF by simply reversing the operations of the first process described above. As the full azimuth points are stored in the spherical table, there may be no need to additionally scale the azimuth. All three coordinates are scaled back to the original domain using offset and scale to obtain the PRF-A, posSph0*, which may be used for inter-prediction of attributes, as illustrated in FIG. 23.

For example, in FIG. 23, SphTable0* 2300 includes rad* component 2302, phi* component 2304, and laserID* component 2306. Offset and scale 2308, 2310, and 2312 are applied to includes rad* component 2302, phi* component 2304, and laserID* component 2306 to generate includes rad** component 2314, phi** component 2316, and laserID** component 2318 of posSph0* 2320.

In the example of FIG. 23, PRF-A (e.g., posSph0* 2320) is generated from PRF (e.g., SphTable0* 2302) by simply reversing the operations of first process described above. First the quantized azimuth is scaled back to the original domain; then a scale and offset may be applied to obtain the PRF-A, posSph0-PRF-A, which may be used for inter-prediction of attributes.

In one or more examples, the PRF may be generated directly from the UPRF (unlike transformed UPRF in earlier examples), as shown in FIG. 24. The method of generating the PRF SphTable0 may be the same as what is currently used. The PRF-A posSph0*x that is used for inter prediction of attributes is derived (using the second process) from PRF SphTable0.

For example, G-PCC encoder 200 and G-PCC decoder 300 may apply a first process to a reference point cloud frame (e.g., posSph0 2400) to generate a first level processed frame (e.g., SphTable0 2404). As one example, G-PCC encoder 200 and G-PCC decoder 300 may perform the example techniques of FIG. 18, 21, or 22.

For example, to apply the first process to the reference point cloud frame to generate the first level processed frame, G-PCC encoder 200 and G-PCC decoder 300 may, for each of a plurality of quantized azimuth components (e.g., qphi) and for a laser identification component (e.g., laserID), store, in a table, a radius component (e.g., rad) and an azimuth component (e.g., phi) for k number of points of the reference point cloud frame associated with the laser identification component. The value of k may greater than or equal to 1, and signaled, received, or preset. In some examples, each of the plurality of quantized azimuth components is an index to the table, and the table is at least a portion of the first level processed frame. For instance, SphTable0 2404 may be at least a portion of the first level processed frame.

G-PCC encoder 200 and G-PCC decoder 300 may apply a second process to the first level processed frame (e.g., SphTable0 2404) to generate a second level processed frame (e.g., posSph0*x 2406 also called posSph0**). For example, to apply the second process to the first level processed frame to generate the second level processed frame, G-PCC encoder 200 and G-PCC decoder 300 may, for each point in the first level processed frame (e.g., SphTable0 2404), apply an offset and a scale to one or more of a radius component, an azimuth component, and a laser identification component to generate the second level processed frame (e.g., posSph0*x 2406). As one example, G-PCC encoder 200 and G-PCC decoder 300 may perform the example techniques illustrated in FIG. 23 to generate posSph0*x 2406.

As described, the example techniques may promote efficient memory usage. For example, G-PCC encoder 200 and G-PCC decoder 300 may store the first level processed frame (e.g., SphTable0 2404) in a buffer, and to apply the second process to the first level processed frame (e.g., SphTable0 2404) to generate the second level processed frame (e.g., posSph0*x 2406), G-PCC encoder 200 and G-PCC decoder 300 may access the first level processed frame (e.g., SphTable0 2404) from the buffer. In this manner, one buffer that stores SphTable0 2404 may be maintained from frame-to-frame.

G-PCC encoder 200 may inter-prediction encode and G-PCC decoder 300 may inter-prediction decode geometry data of points of a current point cloud frame using the first level processed frame (e.g., SphTable0 2404). G-PCC encoder 200 may inter-prediction encode and G-PCC decoder 300 may inter-prediction decode attribute data of points of the current point cloud frame using the second level processed frame (posSph0*x 2406).

The geometry data may include at least coordinate data, and the attribute data may include at least color data, reflectance data, or both color data and reflectance data. In one or more examples, the first level processed frame (e.g., SphTable0 2404) and the second level processed frame (posSph0*x 2406) may include coordinate information. The coordinate information in SphTable0 2404 is used for inter-prediction encoding or decode geometry data, and the coordinate information in posSph0*x 2406 is used for encoding or decoding attribute data. For instance, the actual attribute data (e.g., color, reflectance, etc.) may be associated with the coordinate information of points in the second level processed frame (e.g., posSph0*x 2406). Accordingly, both the first level processed frame and the second level processed frame may include coordinate information, but the coordinate information in the first level processed frame may be used for inter-prediction encoding or decoding geometry data, and the coordinate information in the second level processed frame may be used for inter-prediction encoding or decoding attribute data.

As illustrated in FIG. 24, in one or more examples, G-PCC encoder 200 and G-PCC decoder 300 may appl a third process to generate information (e.g., posSph0* 2402) for encoding or decoding (e.g., inter- or intra-prediction encoding or decoding) attribute data of points of the reference point cloud frame. For example, G-PCC encoder 200 and G-PCC decoder 300 may perform the example techniques of FIG. 16 to generate posSph0* 2402. G-PCC encoder 200 may encode and G-PCC decoder 300 may decode attribute data of points in the reference point cloud frame using the information (e.g., posSph0* 2402).

In one or more examples, G-PCC encoder 200 and G-PCC decoder 300 may perform the example techniques when inter-prediction is enabled. For example, G-PCC encoder 200 and G-PCC decoder 300 may determine that inter-prediction encoding or decoding is enabled for the current point cloud frame. In this case, to apply the first process and applying the second process, G-PCC encoder 200 and G-PCC decoder 300 may apply the first process and apply the second process only in a condition where determined that inter-prediction encoding or decoding is enabled for the current point cloud frame.

The quantization of azimuth values for inter prediction under predictive geometry coding is controlled using the syntax element inter_azim_scale_log 2. This syntax element is used to quantize the azimuth values, which is then used as an index in the inter predictive geometry coding reference (along with laser index) SphTable0; these two indices together specify a bin in the reference table, and each bin contains one point. The smallest value of the azimuth scale value (which corresponds to inter_azim_scale_log 2 equal to 0) specifies that there is no quantization of points. However, as each bin only contains one point, when the multiple points contain the same azimuth value, some points are not stored in the reference table. This results in loss of fidelity of the reference frame.

It may be desirable to have at least one mode by which the reference frame is not quantized or by which fidelity is not affected. Some signaling techniques do not support this case.

In one or more examples, G-PCC encoder 200 may signal an indication which indicates that quantization is not to be performed of the points in the reference frame. Quantization in this case may also include dropping of points. The signaling may be implemented in one of many ways:
a. a flag may be signaled to indicate that quantization of points in reference frame is not to be performed. When this flag indicates that quantization is not to be performed, other syntax elements that are related to quantization (e.g., inter_azim_scale_log 2) may not be signaled.
b. the syntax element inter_azim_scale_log 2 may be signaled as inter_azim_scale_log 2_plus1; if inter_azim_scale_log 2_plus1 is equal to 0, quantization is not performed; else, quantization is performed with inter_azim_scale_log 2 set equal to inter_azim_scale_log 2_plus1−1.

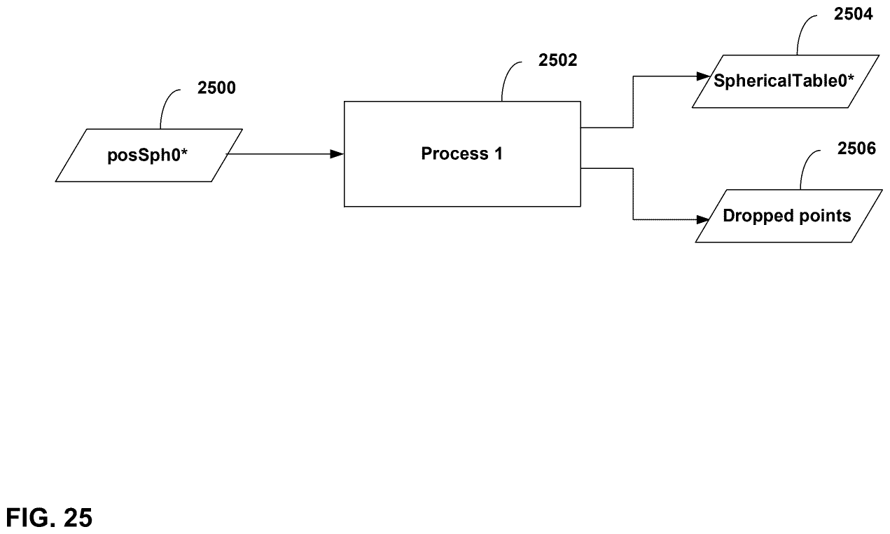

In some examples, points in a reference frame may be dropped/not included and the remaining points may be used for inter prediction (e.g., inter prediction of geometry); however, the points that are dropped are kept in a separate list so that they may be used for later coding (e.g., inter prediction of attributes). FIGS. 25-27 illustrate this.

In FIG. 25, the spherical table SphericalTable0* 2504 is generated from the UPRF posSph0* 2500 using process 1 2502; the points from posSph0* 2500 that are not included in the spherical table are output as dropped points 2506. In this case, the spherical table may be generated with quantized azimuth for lookup.

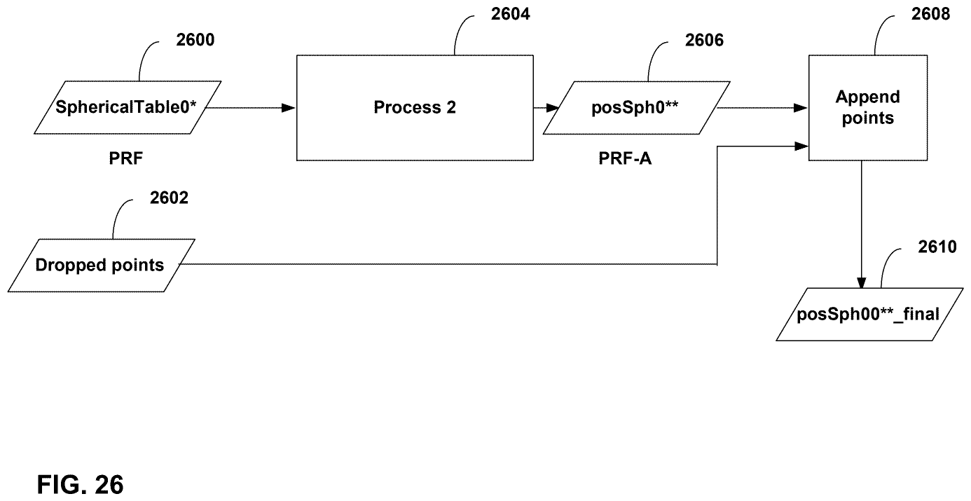

FIG. 26 shows that the PRF SphericalTable0* 2600 may be processed using the second process, Process 2 2604, to obtain PRF-A posSph0** 2606. However, instead of using posSph0** 2606 directly for inter-prediction of attributes, the dropped points from Process 1 are also appended (e.g., append points 2608) to obtain the spherical coordinate representation posSph0**_final 2610. In some cases, the second process may be redefined to include both Process 2 as well as the appending of points. Accordingly, posSph0**_final 2610 is an example of a second level processed frame that is generated from a first level processed frame (e.g., SphericalTable0* 2600) that is used for inter-prediction encoding or decoding attribute date of points of the current point cloud frame.

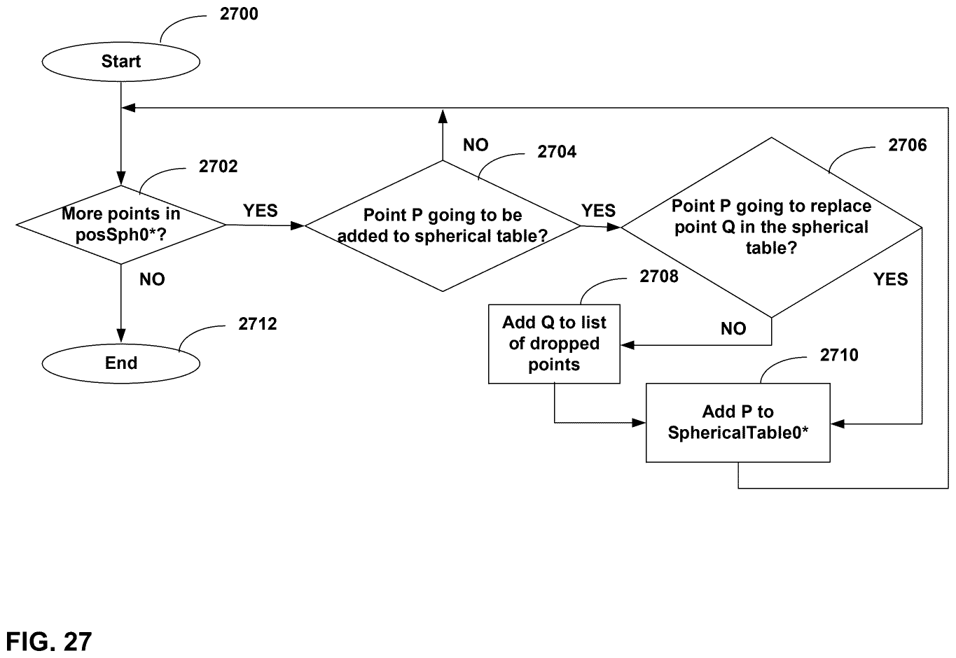

FIG. 27 shows how Process 1 may be modified to also output the list of dropped points. The example of FIG. 27 starts at start 2700, and G-PCC encoder 200 and G-PCC decoder 300 may determine whether there are more points in posSph0* 2702. If there are no more points (NO of 2702), the example techniques may end 2712. If there are more points (YES of 2702), G-PCC encoder 200 and G-PCC decoder 300 may determine whether point P is going to added to spherical table (2704).

If not going to be added (NO of 2704), the example may return back to start 2700. If going to be added (YES of 2704), G-PCC encoder 200 and G-PCC decoder 300 may determine if point P is going to replace point Q in the spherical table (2706). If going to replace (YES of 2706), G-PCC encoder 200 and G-PCC decoder 300 may add P to SphericalTable0* (2710), and return to start 2700. If not going to replace (NO of 2706), G-PCC encoder 200 and G-PCC decoder 300 may add Q to list of dropped points (2708), add P to SphericalTable0* (2710), and return to start 2700.

In this manner, points in UPRF posSph0* are parsed, and based on one or more conditions, a point P in the UPRF may be determined to be added in the SphericalTable0*. If point P is going to replace another point Q that is already in the spherical table, then Q is added to the list of dropped points. If the one or more conditions are satisfied, P is added to the spherical table.

The above example techniques are applicable both at the G-PCC encoder 200 as well as the G-PCC decoder 300. The difference in processing at encoder and decoder would be with respect to the indication (e.g., a flag may be signaled) that points are dropped in process 1 which may then be used in the generation of processed reference frame used for inter attribute prediction.

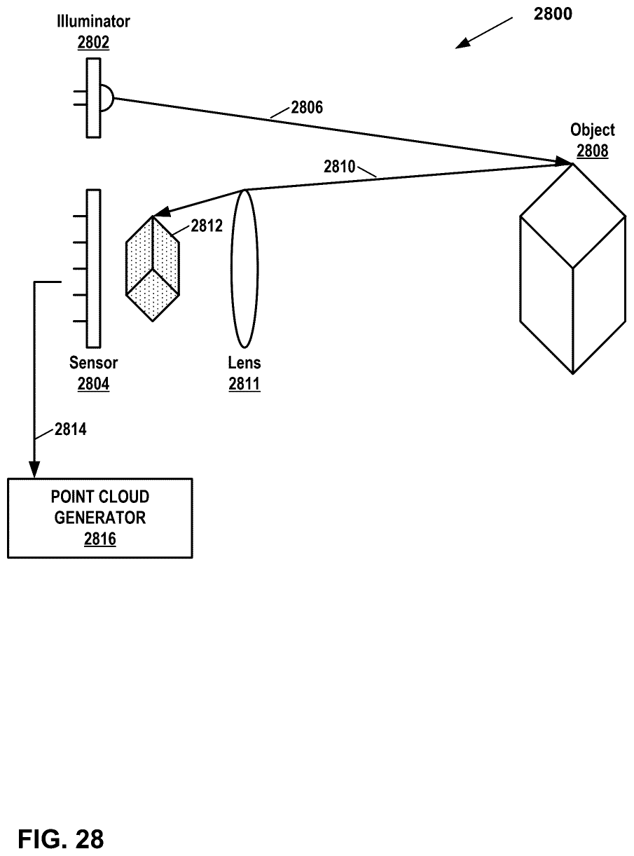

FIG. 28 is a conceptual diagram illustrating an example range-finding system 2800 that may be used with one or more techniques of this disclosure. In the example of FIG. 28, range-finding system 2800 includes an illuminator 2802 and a sensor 2804. Illuminator 2802 may emit light 2806. In some examples, illuminator 2802 may emit light 2806 as one or more laser beams. Light 2806 may be in one or more wavelengths, such as an infrared wavelength or a visible light wavelength. In other examples, light 2806 is not coherent, laser light. When light 2806 encounters an object, such as object 2808, light 2806 creates returning light 2810. Returning light 2810 may include backscattered and/or reflected light. Returning light 2810 may pass through a lens 2811 that directs returning light 2810 to create an image 2812 of object 2808 on sensor 2804. Sensor 2804 generates signals 2814 based on image 2812. Image 2812 may comprise a set of points (e.g., as represented by dots in image 2812 of FIG. 28).

In some examples, illuminator 2802 and sensor 2804 may be mounted on a spinning structure so that illuminator 2802 and sensor 2804 capture a 360-degree view of an environment (e.g., a spinning LIDAR sensor). In other examples, range-finding system 2800 may include one or more optical components (e.g., mirrors, collimators, diffraction gratings, etc.) that enable illuminator 2802 and sensor 2804 to detect ranges of objects within a specific range (e.g., up to 360-degrees). Although the example of FIG. 28 only shows a single illuminator 2802 and sensor 2804, range-finding system 2800 may include multiple sets of illuminators and sensors.

In some examples, illuminator 2802 generates a structured light pattern. In such examples, range-finding system 2800 may include multiple sensors 2804 upon which respective images of the structured light pattern are formed. Range-finding system 2800 may use disparities between the images of the structured light pattern to determine a distance to an object 2808 from which the structured light pattern backscatters. Structured light-based range-finding systems may have a high level of accuracy (e.g., accuracy in the sub-millimeter range), when object 2808 is relatively close to sensor 2804 (e.g., 0.2 meters to 2 meters). This high level of accuracy may be useful in facial recognition applications, such as unlocking mobile devices (e.g., mobile phones, tablet computers, etc.) and for security applications.

In some examples, range-finding system 2800 is a time of flight (ToF)-based system. In some examples where range-finding system 2800 is a ToF-based system, illuminator 2802 generates pulses of light. In other words, illuminator 2802 may modulate the amplitude of emitted light 2806. In such examples, sensor 2804 detects returning light 2810 from the pulses of light 2806 generated by illuminator 2802. Range-finding system 2800 may then determine a distance to object 2808 from which light 2806 backscatters based on a delay between when light 2806 was emitted and detected and the known speed of light in air). In some examples, rather than (or in addition to) modulating the amplitude of the emitted light 2806, illuminator 2802 may modulate the phase of the emitted light 2806. In such examples, sensor 2804 may detect the phase of returning light 2810 from object 2808 and determine distances to points on object 2808 using the speed of light and based on time differences between when illuminator 2802 generated light 2806 at a specific phase and when sensor 2804 detected returning light 2810 at the specific phase.

In other examples, a point cloud may be generated without using illuminator 2802. For instance, in some examples, sensors 2804 of range-finding system 2800 may include two or more optical cameras. In such examples, range-finding system 2800 may use the optical cameras to capture stereo images of the environment, including object 2808. Range-finding system 2800 may include a point cloud generator 2816 that may calculate the disparities between locations in the stereo images. Range-finding system 2800 may then use the disparities to determine distances to the locations shown in the stereo images. From these distances, point cloud generator 2816 may generate a point cloud.

Sensors 2804 may also detect other attributes of object 2808, such as color and reflectance information. In the example of FIG. 28, a point cloud generator 2816 may generate a point cloud based on signals 2814 generated by sensor 2804. Range-finding system 2800 and/or point cloud generator 2816 may form part of data source 104 (FIG. 1). Hence, a point cloud generated by range-finding system 2800 may be encoded and/or decoded according to any of the techniques of this disclosure. Inter prediction and residual prediction, as described in this disclosure may reduce the size of the encoded data.

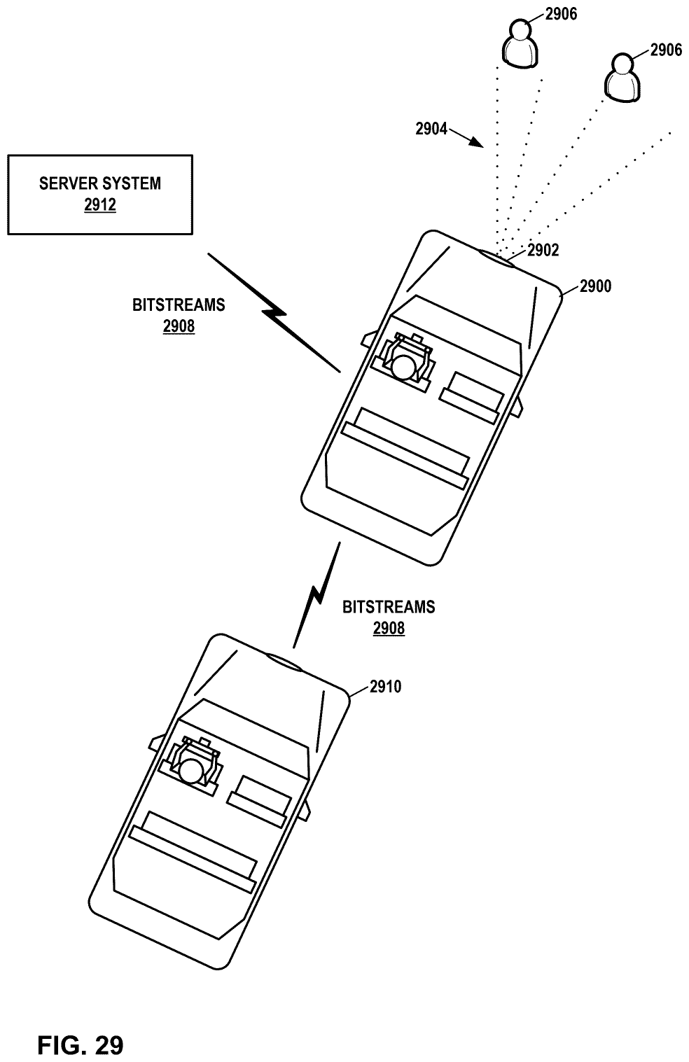

FIG. 29 is a conceptual diagram illustrating an example vehicle-based scenario in which one or more techniques of this disclosure may be used. In the example of FIG. 29, a vehicle 2900 includes a range-finding system 2902. Range-finding system 2902 may be implemented in the manner discussed with respect to FIG. 28. Although not shown in the example of FIG. 29, vehicle 2900 may also include a data source, such as data source 104 (FIG. 1), and a G-PCC encoder, such as G-PCC encoder 200 (FIG. 1). In the example of FIG. 29, range-finding system 2902 emits laser beams 2904 that reflect off pedestrians 2906 or other objects in a roadway. The data source of vehicle 2900 may generate a point cloud based on signals generated by range-finding system 2902. The G-PCC encoder of vehicle 2900 may encode the point cloud to generate bitstreams 2908, such as geometry bitstream (FIG. 2) and attribute bitstream (FIG. 2). Inter prediction and residual prediction, as described in this disclosure may reduce the size of the geometry bitstream. Bitstreams 2908 may include many fewer bits than the unencoded point cloud obtained by the G-PCC encoder.

An output interface of vehicle 2900 (e.g., output interface 108 (FIG. 1) may transmit bitstreams 2908 to one or more other devices. Bitstreams 2908 may include many fewer bits than the unencoded point cloud obtained by the G-PCC encoder. Thus, vehicle 2900 may be able to transmit bitstreams 2908 to other devices more quickly than the unencoded point cloud data. Additionally, bitstreams 2908 may require less data storage capacity on a device.

In the example of FIG. 29, vehicle 2900 may transmit bitstreams 2908 to another vehicle 2910. Vehicle 2910 may include a G-PCC decoder, such as G-PCC decoder 300 (FIG. 1). The G-PCC decoder of vehicle 2910 may decode bitstreams 2908 to reconstruct the point cloud. Vehicle 2910 may use the reconstructed point cloud for various purposes. For instance, vehicle 2910 may determine based on the reconstructed point cloud that pedestrians 2906 are in the roadway ahead of vehicle 2900 and therefore start slowing down, e.g., even before a driver of vehicle 2910 realizes that pedestrians 2906 are in the roadway. Thus, in some examples, vehicle 2910 may perform an autonomous navigation operation based on the reconstructed point cloud.

Additionally, or alternatively, vehicle 2900 may transmit bitstreams 2908 to a server system 2912. Server system 2912 may use bitstreams 2908 for various purposes. For example, server system 2912 may store bitstreams 2908 for subsequent reconstruction of the point clouds. In this example, server system 2912 may use the point clouds along with other data (e.g., vehicle telemetry data generated by vehicle 2900) to train an autonomous driving system. In other example, server system 2912 may store bitstreams 2908 for subsequent reconstruction for forensic crash investigations.

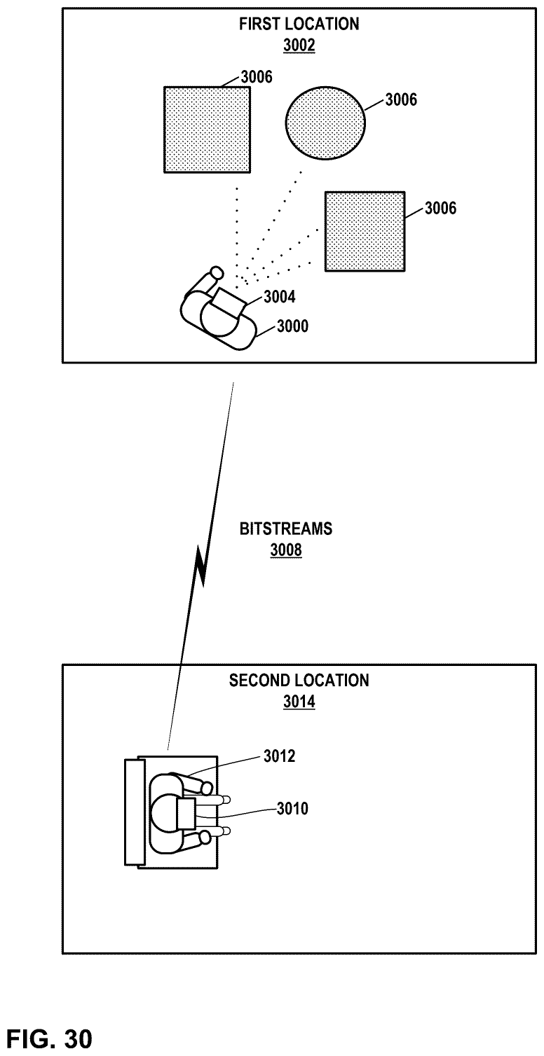

FIG. 30 is a conceptual diagram illustrating an example extended reality system in which one or more techniques of this disclosure may be used. Extended reality (XR) is a term used to cover a range of technologies that includes augmented reality (AR), mixed reality (MR), and virtual reality (VR). In the example of FIG. 30, a user 3000 is located in a first location 3002. User 3000 wears an XR headset 3004. As an alternative to XR headset 3004, user 3000 may use a mobile device (e.g., mobile phone, tablet computer, etc.). XR headset 3004 includes a depth detection sensor, such as a range-finding system, that detects positions of points on objects 3006 at location 3002. A data source of XR headset 3004 may use the signals generated by the depth detection sensor to generate a point cloud representation of objects 3006 at location 3002. XR headset 3004 may include a G-PCC encoder (e.g., G-PCC encoder 200 of FIG. 1) that is configured to encode the point cloud to generate bitstreams 3008. Inter prediction and residual prediction, as described in this disclosure may reduce the size of bitstream 3008.

XR headset 3004 may transmit bitstreams 3008 (e.g., via a network such as the Internet) to an XR headset 3010 worn by a user 3012 at a second location 3014. XR headset 3010 may decode bitstreams 3008 to reconstruct the point cloud. XR headset 3010 may use the point cloud to generate an XR visualization (e.g., an AR, MR, VR visualization) representing objects 3006 at location 3002. Thus, in some examples, such as when XR headset 3010 generates an VR visualization, user 3012 may have a 3D immersive experience of location 3002. In some examples, XR headset 3010 may determine a position of a virtual object based on the reconstructed point cloud. For instance, XR headset 3010 may determine, based on the reconstructed point cloud, that an environment (e.g., location 3002) includes a flat surface and then determine that a virtual object (e.g., a cartoon character) is to be positioned on the flat surface. XR headset 3010 may generate an XR visualization in which the virtual object is at the determined position. For instance, XR headset 3010 may show the cartoon character sitting on the flat surface.

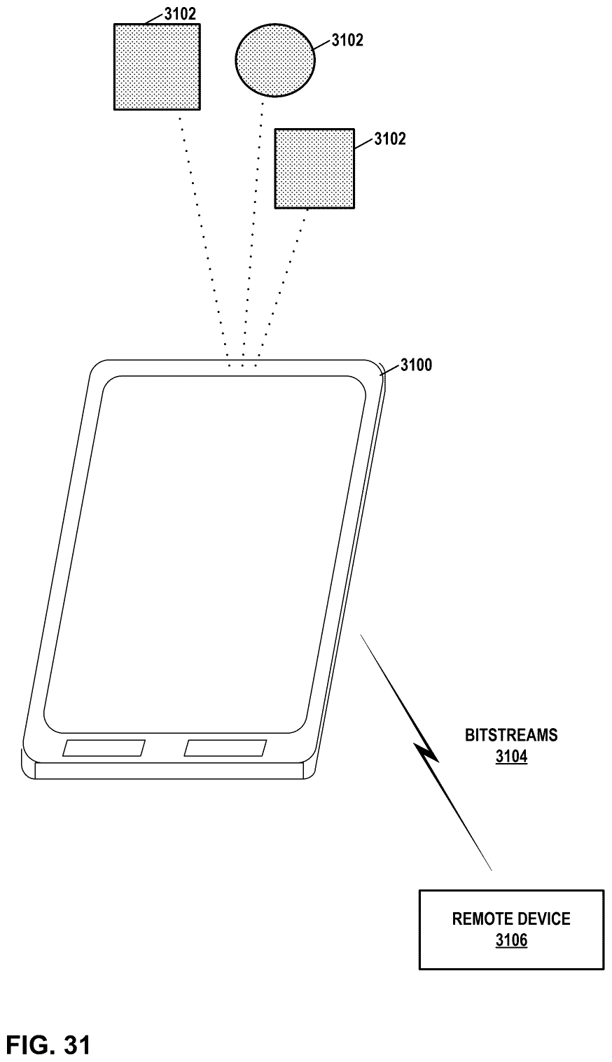

FIG. 31 is a conceptual diagram illustrating an example mobile device system in which one or more techniques of this disclosure may be used. In the example of FIG. 31, a mobile device 3100 (e.g., a wireless communication device), such as a mobile phone or tablet computer, includes a range-finding system, such as a LIDAR system, that detects positions of points on objects 3102 in an environment of mobile device 3100. A data source of mobile device 3100 may use the signals generated by the depth detection sensor to generate a point cloud representation of objects 3102. Mobile device 3100 may include a G-PCC encoder (e.g., G-PCC encoder 200 of FIG. 1) that is configured to encode the point cloud to generate bitstreams 3104. In the example of FIG. 31, mobile device 3100 may transmit bitstreams to a remote device 3106, such as a server system or other mobile device. Inter prediction and residual prediction, as described in this disclosure may reduce the size of bitstreams 3104. Remote device 3106 may decode bitstreams 3104 to reconstruct the point cloud. Remote device 3106 may use the point cloud for various purposes. For example, remote device 3106 may use the point cloud to generate a map of environment of mobile device 3100. For instance, remote device 3106 may generate a map of an interior of a building based on the reconstructed point cloud. In another example, remote device 3106 may generate imagery (e.g., computer graphics) based on the point cloud. For instance, remote device 3106 may use points of the point cloud as vertices of polygons and use color attributes of the points as the basis for shading the polygons. In some examples, remote device 3106 may use the reconstructed point cloud for facial recognition or other security applications.

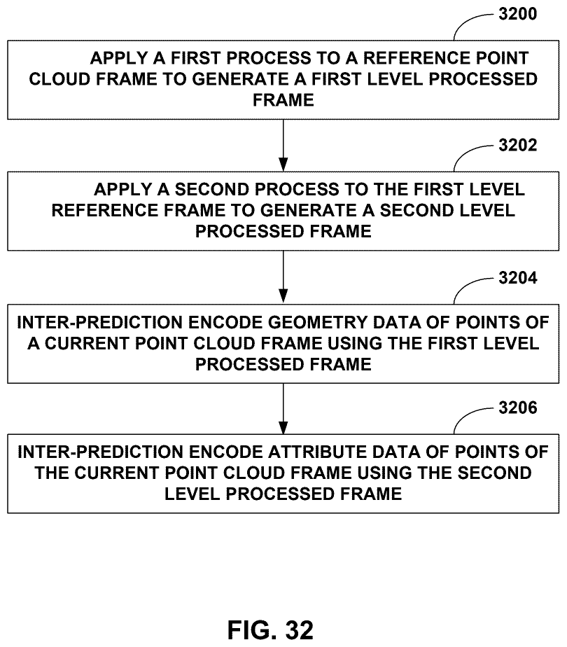

FIG. 32 is a flowchart illustrating example techniques of decoding point cloud data. The example of FIG. 32 is described with respect to processing circuitry, such as processing circuitry of G-PCC encoder 200. A device that includes G-PCC encoder 200 may also include one or more LiDAR sensors configured to capture points of a current point cloud frame whose attribute data and geometry data G-PCC encoder 200 is to encode.

The processing circuitry of G-PCC encoder 200 may be configured to apply a first process to a reference point cloud frame to generate a first level processed frame (3200). The processing circuitry of G-PCC encoder 200 may be configured to for each of a plurality of quantized azimuth components and for a laser identification component, store, in a table, a radius component and an azimuth component for k number of points of the reference point cloud frame associated with the laser identification component. In this example, k may be greater than or equal to 1, and a value of k may be signaled or received, or preset. The plurality of quantized azimuth components may be an index to the table, and the table is at least a portion of the first level processed frame. Example techniques to generate the first level processed frame include examples illustrated in FIGS. 18 and 21, as two non-limiting examples, where SphTable0 is an example of the first level processed frame.

The processing circuitry of G-PCC encoder 200 may apply a second process to the first level processed frame to generate a second level processed frame (3202). For instance, as illustrated FIG. 24, posSph0*x 2406, which is an example of the second level processed frame, is generated from SphTable0. As an example, to apply the second process to the first level processed frame to generate the second level processed frame, the processing circuitry of G-PCC encoder 200 may be configured to for each point in the first level processed frame, apply an offset and a scale to one or more of a radius component, an azimuth component, and a laser identification component to generate the second level processed frame. Example techniques to generate the second level processed frame are illustrated in FIGS. 16 and 23, as two non-limiting examples, where posSph0*x or posSph0** are examples of the second level processed frame.

As an example, the processing circuitry of G-PCC encoder 200 may store the first level processed frame in a buffer. To apply the second process to the first level processed frame to generate the second level processed frame, the processing circuitry of G-PCC encoder 200 may be configured to access the first level processed frame from the buffer.

The processing circuitry of G-PCC encoder 200 may be configured to inter-prediction encode geometry data of points of a current point cloud frame using the first level processed frame (3204). The geometry data may include at least coordinate data.

The processing circuitry of G-PCC encoder 200 may be configured to inter-prediction encode attribute data of points of the current point cloud frame using the second level processed frame (3206). The attribute data may include at least color data, reflectance data, or both color data and reflectance data.

In some examples, the processing circuitry of G-PCC encoder 200 may be configured to apply a third process to generate information for encoding (e.g., inter- or intra-prediction encoding) attribute data of points of the reference point cloud frame, and encode attribute data of the points of the reference point cloud frame using the information. For example, as illustrated in FIG. 24, the processing circuitry of G-PCC encoder 200 may generate posSph0* 2402 from posSph0 2400. The processing circuitry of G-PCC encoder 200 may use posSph0* 2402 for encoding (e.g., intra-prediction encoding) attribute data of points of the reference point cloud frame, but use posSph0*x 2406 for inter-prediction encoding attribute data of points of the current point cloud frame. As illustrated in FIG. 24, the processing circuitry of G-PCC encoder 200 may generate posSph0*x 2406 (e.g., second level processed frame) from SphTable0 2404 (e.g., first level processed frame), where SphTable0 2404 is generated from posSph0 (e.g., reference point cloud frame).

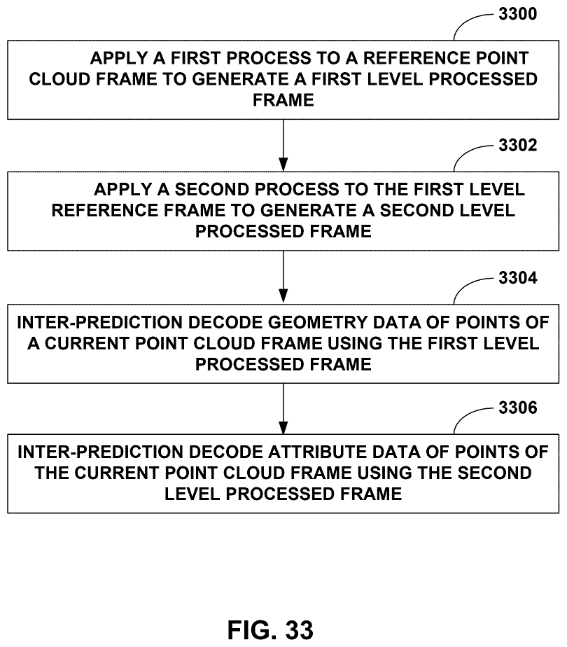

FIG. 33 is a flowchart illustrating example techniques of decoding point cloud data. The example of FIG. 33 is described with respect to processing circuitry, such as processing circuitry of G-PCC decoder 300. A device that includes G-PCC decoder 300 may also include a display configured to present imagery based on a current point cloud frame whose attribute data and geometry data G-PCC decoder 300 is to decode.

The processing circuitry of G-PCC decoder 300 may be configured to apply a first process to a reference point cloud frame to generate a first level processed frame (3300). The processing circuitry of G-PCC decoder 300 may be configured to for each of a plurality of quantized azimuth components and for a laser identification component, store, in a table, a radius component and an azimuth component for k number of points of the reference point cloud frame associated with the laser identification component.

In this example, k may be greater than or equal to 1, and a value of k may be signaled or received, or preset. The plurality of quantized azimuth components may be an index to the table, and the table is at least a portion of the first level processed frame. Example techniques to generate the first level processed frame include examples illustrated in FIGS. 18 and 21, as two non-limiting examples, where SphTable0 is an example of the first level processed frame.

The processing circuitry of G-PCC decoder 300 may apply a second process to the first level processed frame to generate a second level processed frame (3302). For instance, as illustrated FIG. 24, posSph0*x 2406, which is an example of the second level processed frame, is generated from SphTable0. As an example, to apply the second process to the first level processed frame to generate the second level processed frame, the processing circuitry of G-PCC decoder 300 may be configured to for each point in the first level processed frame, apply an offset and a scale to one or more of a radius component, an azimuth component, and a laser identification component to generate the second level processed frame. Example techniques to generate the second level processed frame are illustrated in FIGS. 16 and 23, as two non-limiting examples, where posSph0*x or posSph0** are examples of the second level processed frame.

As an example, the processing circuitry of G-PCC decoder 300 may store the first level processed frame in a buffer. To apply the second process to the first level processed frame to generate the second level processed frame, the processing circuitry of G-PCC decoder 300 may be configured to access the first level processed frame from the buffer.

The processing circuitry of G-PCC decoder 300 may be configured to inter-prediction decode geometry data of points of a current point cloud frame using the first level processed frame (3304). The geometry data may include at least coordinate data.

The processing circuitry of G-PCC decoder 300 may be configured to inter-prediction decode attribute data of points of the current point cloud frame using the second level processed frame (3306). The attribute data may include at least color data, reflectance data, or both color data and reflectance data.

In some examples, the processing circuitry of G-PCC decoder 300 may be configured to apply a third process to generate information for decoding (e.g., inter- or intra-prediction decoding) attribute data of points of the reference point cloud frame, and decode attribute data of the points of the reference point cloud frame using the information. For example, as illustrated in FIG. 24, the processing circuitry of G-PCC decoder 300 may generate posSph0* 2402 from posSph0 2400. The processing circuitry of G-PCC decoder 300 may use posSph0* 2402 for decoding attribute data of points of the reference point cloud frame, but use posSph0*x 2406 for inter-prediction decoding attribute data of points of the current point cloud frame. As illustrated in FIG. 24, the processing circuitry of G-PCC decoder 300 may generate posSph0*x 2406 (e.g., second level processed frame) from SphTable0 2404 (e.g., first level processed frame), where SphTable0 2404 is generated from posSph0 (e.g., reference point cloud frame).

Examples in the various aspects of this disclosure may be used individually or in any combination.

Clause 1A. A method of coding point cloud data, the method comprising: applying a process to a reference frame to generate a processed frame; and coding a current frame based on the processed frame, wherein the reference frame and the current frame comprise point cloud data frames.

Clause 2A. The method of clause 1A, wherein the process is a first process, wherein the processed frame is a first level processed frame, the method further comprising: applying a second process to the first level processed frame to generate a second level processed frame, wherein coding comprises coding the current frame based on the second level processed frame.

Clause 3A. The method of clause 2A, wherein coding comprises: coding geometry data of the current frame using the first level processed frame; and coding attribute data of the current frame using the second level processed frame.

Clause 4A. The method of any of clauses 2A and 3A, further comprising: signaling or receiving one or more parameters for the first process; and deriving one or more parameters for the second process based on the one or more parameters for the first process.

Clause 5A. The method of any of clauses 2A and 3A, further comprising: signaling or receiving one or more parameters for the second process.

Clause 6A. The method of any of clauses 1A-5A, further comprising: signaling or receiving one or more syntax elements indicating whether to apply the process to the reference frame, wherein applying the process comprises applying the process in a condition where the one or more syntax elements indicate to apply the process.

Clause 7A. The method of any of clauses 1A-6A, wherein coding comprises coding at least one of geometry data of points in a point cloud of the current frame or attribute data of the points in the point cloud of the current frame.

Clause 8A. The method of any of clauses 1A-7A, wherein coding comprises inter-prediction coding.

Clause 9A. The method of any of clauses 1A-8A, wherein coding comprises encoding.

Clause 10A. The method of any of clauses 1A-8A, wherein coding comprises decoding.

Clause 11A. The method of any of clauses 1A-9A, further comprising generating the point cloud data.

Clause 12A. A device for coding point cloud data, the device comprising: one or more memories configured to store the point cloud data; and processing circuitry configured to perform the method of any one or more combination of clauses 1A-11A.

Clause 13A. The device of clause 12A, further comprising a display to present imagery based on the point cloud.

Clause 14A. A computer-readable storage medium having stored thereon instructions that, when executed, cause one or more processors to perform the method of any of clauses 1A-11A.

Clause 15A. A device for coding point cloud data, the device comprising means for performing the method of any of clauses 1A-11A.

Clause 1. A device for decoding point cloud data, the device comprising: one or more memories configured to store the point cloud data; and processing circuitry coupled to the one or more memories, wherein the processing circuitry is configured to: apply a first process to a reference point cloud frame to generate a first level processed frame; apply a second process to the first level processed frame to generate a second level processed frame; inter-prediction decode geometry data of points of a current point cloud frame using the first level processed frame; and inter-prediction decode attribute data of points of the current point cloud frame using the second level processed frame.

Clause 2. The device of clause 1, wherein to apply the first process to the reference point cloud frame to generate the first level processed frame, the processing circuitry is configured to: for each of a plurality of quantized azimuth components and for a laser identification component, store, in a table, a radius component and an azimuth component for k number of points of the reference point cloud frame associated with the laser identification component, wherein k is greater than or equal to 1, wherein each of the plurality of quantized azimuth components is an index to the table, and wherein the table is at least a portion of the first level processed frame.

Clause 3. The device of clause 2, wherein a value of k is received.

Clause 4. The device of any of clauses 1-3, wherein to apply the second process to the first level processed frame to generate the second level processed frame, the processing circuitry is configured to: for each point in the first level processed frame, apply an offset and a scale to one or more of a radius component, an azimuth component, and a laser identification component to generate the second level processed frame.

Clause 5. The device of any of clauses 1-5, wherein the processing circuitry is configured to: store the first level processed frame in a buffer, wherein to apply the second process to the first level processed frame to generate the second level processed frame, the processing circuitry is configured to access the first level processed frame from the buffer.

Clause 6. The device of any of clauses 1-5, wherein the processing circuitry is configured to: apply a third process to generate information for decoding attribute data of points of the reference point cloud frame; and decode attribute data of the points of the reference point cloud frame using the information.

Clause 7. The device of any of clauses 1-6, wherein the geometry data comprises coordinate data, and wherein the attribute data comprises color data, reflectance data, or both color data and reflectance data.

Clause 8. The device of any of clauses 1-7, further comprising a display configured to present imagery based on the current point cloud frame.

Clause 9. A device for encoding point cloud data, the device comprising: one or more memories configured to store the point cloud data; and processing circuitry coupled to the one or more memories, wherein the processing circuitry is configured to: apply a first process to a reference point cloud frame to generate a first level processed frame; apply a second process to the first level processed frame to generate a second level processed frame; inter-prediction encode geometry data of points of a current point cloud frame using the first level processed frame; and inter-prediction encode attribute data of points of the current point cloud frame using the second level processed frame.

Clause 10. The device of clause 9, wherein to apply the first process to the reference point cloud frame to generate the first level processed frame, the processing circuitry is configured to: for each of a plurality of quantized azimuth components and for a laser identification component, store, in a table, a radius component and an azimuth component for k number of points of the reference point cloud frame associated with the laser identification component, wherein k is greater than or equal to 1, wherein each of the plurality of quantized azimuth components is an index to the table, and wherein the table is at least a portion of the first level processed frame.

Clause 11. The device of clause 10, wherein a value of k is signaled.

Clause 12. The device of any of clauses 9-11, wherein to apply the second process to the first level processed frame to generate the second level processed frame, the processing circuitry is configured to: for each point in the first level processed frame, apply an offset and a scale to one or more of a radius component, an azimuth component, and a laser identification component to generate the second level processed frame.

Clause 13. The device of any of clauses 9-12, wherein the processing circuitry is configured to: store the first level processed frame in a buffer, wherein to apply the second process to the first level processed frame to generate the second level processed frame, the processing circuitry is configured to access the first level processed frame from the buffer.

Clause 14. The device of any of clauses 9-13, wherein the processing circuitry is configured to: apply a third process to generate information for encoding attribute data of points of the reference point cloud frame; and encode attribute data of the points of the reference point cloud frame using the information.

Clause 15. The device of any of clauses 9-14, wherein the geometry data comprises coordinate data, and wherein the attribute data comprises color data, reflectance data, or both color data and reflectance data.

Clause 16. The device of any of clauses 9-15, further comprising one or more LiDAR sensors configured to capture the points of the current point cloud frame.

Clause 17. A method of decoding point cloud data, the method comprising: applying a first process to a reference point cloud frame to generate a first level processed frame; applying a second process to the first level processed frame to generate a second level processed frame; inter-prediction decoding geometry data of points of a current point cloud frame using the first level processed frame; and inter-prediction decoding attribute data of points of the current point cloud frame using the second level processed frame.

Clause 18. The method of clause 17, wherein applying the first process to the reference point cloud frame to generate the first level processed frame comprises: for each of a plurality of quantized azimuth components and for a laser identification component, storing, in a table, a radius component and an azimuth component for k number of points of the reference point cloud frame associated with the laser identification component, wherein k is greater than or equal to 1, wherein each of the plurality of quantized azimuth components is an index to the table, and wherein the table is at least a portion of the first level processed frame.

Clause 19. The method of clause 18, wherein a value of k is received.

Clause 20. The method of any of clauses 17-19, wherein applying the second process to the first level processed frame to generate the second level processed frame comprises: for each point in the first level processed frame, applying an offset and a scale to one or more of a radius component, an azimuth component, and a laser identification component to generate the second level processed frame.

Clause 21. The method of any of clauses 17-20, further comprising: storing the first level processed frame in a buffer, wherein applying the second process to the first level processed frame to generate the second level processed frame comprises accessing the first level processed frame from the buffer.

Clause 22. The method of any of clauses 17-21, further comprising: applying a third process to generate information for decoding attribute data of points of the reference point cloud frame; and decoding attribute data of the points of the reference point cloud frame using the information.

Clause 23. The method of any of clauses 17-22, wherein the geometry data comprises coordinate data, and wherein the attribute data comprises color data, reflectance data, or both color data and reflectance data.

Clause 24. One or more computer-readable storage media storing instructions thereon that when executed cause one or more processors to: apply a first process to a reference point cloud frame to generate a first level processed frame; apply a second process to the first level processed frame to generate a second level processed frame; inter-prediction encode geometry data of points of a current point cloud frame using the first level processed frame; and inter-prediction encode attribute data of points of the current point cloud frame using the second level processed frame.

Clause 25. The one or more computer-readable storage media of clause 24, wherein the instructions that cause the one or more processors to apply the first process to the reference point cloud frame to generate the first level processed frame comprise instructions that cause the one or more processors to: for each of a plurality of quantized azimuth components and for a laser identification component, store, in a table, a radius component and an azimuth component for k number of points of the reference point cloud frame associated with the laser identification component, wherein k is greater than or equal to 1, wherein each of the plurality of quantized azimuth components is an index to the table, and wherein the table is at least a portion of the first level processed frame.

Clause 26. The one or more computer-readable storage media of any of clauses 24 and 25, wherein the instructions that cause the one or more processors to apply the second process to the first level processed frame to generate the second level processed frame comprise instructions that cause the one or more processors to: for each point in the first level processed frame, apply an offset and a scale to one or more of a radius component, an azimuth component, and a laser identification component to generate the second level processed frame.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for decoding point cloud data, the device comprising:
one or more memories configured to store the point cloud data; and
processing circuitry coupled to the one or more memories, wherein the processing circuitry is configured to:
apply a first process to a reference point cloud frame to generate a first level processed frame;
apply a second process to the first level processed frame to generate a second level processed frame;
inter-prediction decode geometry data of points of a current point cloud frame using the first level processed frame; and
inter-prediction decode attribute data of points of the current point cloud frame using the second level processed frame.

2. The device of claim 1, wherein to apply the first process to the reference point cloud frame to generate the first level processed frame, the processing circuitry is configured to:
for each of a plurality of quantized azimuth components and for a laser identification component, store, in a table, a radius component and an azimuth component for k number of points of the reference point cloud frame associated with the laser identification component,
wherein k is greater than or equal to 1,
wherein each of the plurality of quantized azimuth components is an index to the table, and
wherein the table is at least a portion of the first level processed frame.

3. The device of claim 2, wherein a value of k is received.

4. The device of claim 1, wherein to apply the second process to the first level processed frame to generate the second level processed frame, the processing circuitry is configured to:
for each point in the first level processed frame, apply an offset and a scale to one or more of a radius component, an azimuth component, and a laser identification component to generate the second level processed frame.

5. The device of claim 1, wherein the processing circuitry is configured to:
store the first level processed frame in a buffer,
wherein to apply the second process to the first level processed frame to generate the second level processed frame, the processing circuitry is configured to access the first level processed frame from the buffer.

6. The device of claim 1, wherein the processing circuitry is configured to:
apply a third process to generate information for decoding attribute data of points of the reference point cloud frame; and
decode attribute data of the points of the reference point cloud frame using the information.

7. The device of claim 1, wherein the geometry data comprises coordinate data, and wherein the attribute data comprises color data, reflectance data, or both color data and reflectance data.

8. The device of claim 1, further comprising a display configured to present imagery based on the current point cloud frame.

9. A device for encoding point cloud data, the device comprising:
one or more memories configured to store the point cloud data; and
processing circuitry coupled to the one or more memories, wherein the processing circuitry is configured to:
apply a first process to a reference point cloud frame to generate a first level processed frame;
apply a second process to the first level processed frame to generate a second level processed frame;
inter-prediction encode geometry data of points of a current point cloud frame using the first level processed frame; and
inter-prediction encode attribute data of points of the current point cloud frame using the second level processed frame.

10. The device of claim 9, wherein to apply the first process to the reference point cloud frame to generate the first level processed frame, the processing circuitry is configured to:
for each of a plurality of quantized azimuth components and for a laser identification component, store, in a table, a radius component and an azimuth component for k number of points of the reference point cloud frame associated with the laser identification component,
wherein k is greater than or equal to 1,
wherein each of the plurality of quantized azimuth components is an index to the table, and
wherein the table is at least a portion of the first level processed frame.

11. The device of claim 10, wherein a value of k is signaled.

12. The device of claim 9, wherein to apply the second process to the first level processed frame to generate the second level processed frame, the processing circuitry is configured to:
for each point in the first level processed frame, apply an offset and a scale to one or more of a radius component, an azimuth component, and a laser identification component to generate the second level processed frame.

13. The device of claim 9, wherein the processing circuitry is configured to:
store the first level processed frame in a buffer,
wherein to apply the second process to the first level processed frame to generate the second level processed frame, the processing circuitry is configured to access the first level processed frame from the buffer.

14. The device of claim 9, wherein the processing circuitry is configured to:
apply a third process to generate information for encoding attribute data of points of the reference point cloud frame; and
encode attribute data of the points of the reference point cloud frame using the information.

15. The device of claim 9, wherein the geometry data comprises coordinate data, and wherein the attribute data comprises color data, reflectance data, or both color data and reflectance data.

16. The device of claim 9, further comprising one or more LiDAR sensors configured to capture the points of the current point cloud frame.

17. A method of decoding point cloud data, the method comprising:
applying a first process to a reference point cloud frame to generate a first level processed frame;
applying a second process to the first level processed frame to generate a second level processed frame;
inter-prediction decoding geometry data of points of a current point cloud frame using the first level processed frame; and
inter-prediction decoding attribute data of points of the current point cloud frame using the second level processed frame.

18. The method of claim 17, wherein applying the first process to the reference point cloud frame to generate the first level processed frame comprises:
for each of a plurality of quantized azimuth components and for a laser identification component, storing, in a table, a radius component and an azimuth component for k number of points of the reference point cloud frame associated with the laser identification component,
wherein k is greater than or equal to 1,
wherein each of the plurality of quantized azimuth components is an index to the table, and
wherein the table is at least a portion of the first level processed frame.

19. The method of claim 18, wherein a value of k is received.

20. The method of claim 17, wherein applying the second process to the first level processed frame to generate the second level processed frame comprises:
for each point in the first level processed frame, applying an offset and a scale to one or more of a radius component, an azimuth component, and a laser identification component to generate the second level processed frame.

21. The method of claim 17, further comprising:
storing the first level processed frame in a buffer,
wherein applying the second process to the first level processed frame to generate the second level processed frame comprises accessing the first level processed frame from the buffer.

22. The method of claim 17, further comprising:
applying a third process to generate information for decoding attribute data of points of the reference point cloud frame; and
decoding attribute data of the points of the reference point cloud frame using the information.

23. The method of claim 17, wherein the geometry data comprises coordinate data, and wherein the attribute data comprises color data, reflectance data, or both color data and reflectance data.

24. One or more computer-readable storage media storing instructions thereon that when executed cause one or more processors to:
apply a first process to a reference point cloud frame to generate a first level processed frame;
apply a second process to the first level processed frame to generate a second level processed frame;
inter-prediction encode geometry data of points of a current point cloud frame using the first level processed frame; and
inter-prediction encode attribute data of points of the current point cloud frame using the second level processed frame.

25. The one or more computer-readable storage media of claim 24, wherein the instructions that cause the one or more processors to apply the first process to the reference point cloud frame to generate the first level processed frame comprise instructions that cause the one or more processors to:
for each of a plurality of quantized azimuth components and for a laser identification component, store, in a table, a radius component and an azimuth component for k number of points of the reference point cloud frame associated with the laser identification component,
wherein k is greater than or equal to 1,
wherein each of the plurality of quantized azimuth components is an index to the table, and
wherein the table is at least a portion of the first level processed frame.

26. The one or more computer-readable storage media of claim 24, wherein the instructions that cause the one or more processors to apply the second process to the first level processed frame to generate the second level processed frame comprise instructions that cause the one or more processors to:
for each point in the first level processed frame, apply an offset and a scale to one or more of a radius component, an azimuth component, and a laser identification component to generate the second level processed frame.
